(19) United States
(12) Patent Application Publication
(10) Pub. No.: US 2013/0104032 A1
(43) Pub. Date: Apr. 25, 2013

(54) MOBILE TERMINAL AND METHOD OF CONTROLLING THE SAME

(71) Applicants: Jiyoun Lee, Seoul (KR); Jeongyun Heo, Seoul (KR); Youneui Choi, Seoul (KR); Eunjeong Ryu, Seoul (KR); Miyoung Kim, Seoul (KR); Jiyeon Kim, Seoul (KR); Jeeyeon Kim, Seoul (KR); Sohoon Yi, Seoul (KR)

(72) Inventors: Jiyoun Lee, Seoul (KR); Jeongyun Heo, Seoul (KR); Youneui Choi, Seoul (KR); Eunjeong Ryu, Seoul (KR); Miyoung Kim, Seoul (KR); Jiyeon Kim, Seoul (KR); Jeeyeon Kim, Seoul (KR); Sohoon Yi, Seoul (KR)

(21) Appl. No.: 13/653,865

(22) Filed: Oct. 17, 2012

(30) Foreign Application Priority Data
Oct. 19, 2011 (KR) 10-2011-0106727
Nov. 18, 2011 (KR) 10-2011-0120584

(51) Int. Cl. G06K 9/60; G06F 17/00

(52) U.S. Cl. 715/234; 382/305

(57) ABSTRACT

A mobile terminal and a method of controlling the same are provided. The mobile terminal captures an image relating to a predetermined item displayed on a touchscreen, maps attribute information relating to the item to the capture image, stores the capture image, and uses the capture image on the basis of the attribute information. Accordingly, a desired item is used more easily.

### CROSS-REFERENCE TO RELATED APPLICATION

This application claims priority under 35 U.S.C. §119 to Korean Application No. 10-2011-0106727 filed Oct. 19, 2011 and Korean Application No. 10-2011-0120584 filed Nov. 18, 2011, whose entire disclosures are hereby incorporated by reference.

### BACKGROUND

1. Field

The present invention relates to a mobile terminal and a method of controlling the same.

2. Background

With diversification of functions of terminals such as a personal computer, a notebook computer, a cellular phone, etc., the terminals are implemented in the form of a multimedia player having multifunctions of photographing pictures or moving pictures, playing music or video files, playing games, receiving broadcast programs, etc.

Terminals can be divided into mobile terminals and stationary terminals. The mobile terminals can be classified as handheld terminals or vehicle mounted terminals according to whether users can personally carry the terminals.

It can be consider to improve a structural part and/or a software part of a terminal in order to support and enhance functions of the terminal.

As recent various terminals including a mobile terminal provide a variety of functions, a complicated function setting procedure is required to actively use these functions.

Particularly, it may be difficult for a user to set a function when this function is frequently used by a user, and a technique for easily performing the function setting procedure is needed for people who has difficulty in the complicated function setting procedure.

Accordingly, it is necessary to simplify a complicated function setting structure for various functions to provide a convenient user interface (UI) to users.

### SUMMARY

An object of the present invention is to provide a mobile terminal and a method of controlling the same to store a desired item in the form of an image and to use attributes of the image when a user wants to use the item later.

Another object of the present invention is to provide a mobile terminal and a method of controlling the same by which a user can recognize an item provided through a screen of the mobile terminal more intuitively by mapping a capture image of the item with attribute information of the item.

Another object of the present invention is to provide a mobile terminal and a method of controlling the same by which various services can be shared through a easier method by sharing a capture image mapped with an attribute with other terminals.

Another object of the present invention is to provide a mobile terminal and a method of controlling the same to improve usage of the mobile terminal by easily setting an operation state of the mobile terminal.

Another object of the present invention is to provide a mobile terminal and a method of controlling the same to simplify complicated function setting structures for functions of the mobile terminal according to increasingly diversified functions of the mobile terminal to provide a convenient user interface (UI) to a user.

According to one aspect of the present invention, a mobile terminal includes a touchscreen displaying an image relating to a predetermined item, and a controller configured to capture the image relating to the item, to map attribute information about the item to the capture image and store the capture image, and to execute the item corresponding to the capture image on the basis of the attribute information when a predefined touch input for the capture image is received.

According to another aspect of the present invention, a mobile terminal includes a memory, a touchscreen, and a controller configured to display a web page on the touchscreen, to capture a screen on which the web page is displayed to generate a capture image, to map a URL corresponding to the web page to the capture image and store the web page in the memory, to select one of capture images stored in the memory and, when a touch input predefined for the selected capture image is received, to use the capture image as the web page corresponding to the URL by applying a URL corresponding to the selected capture image.

According to another aspect of the present invention, a mobile terminal includes a communication unit, and a controller configured to receive a capture image to which attribute information for executing an item is mapped, through the communication unit and, when a touch input predefined for the capture image is received, to execute an item corresponding to the capture image on the basis of the attribute information.

According to another aspect of the present invention, a method of controlling a mobile terminal includes displaying an image relating to a predetermined item on a touchscreen, capturing the image relating to the item, mapping attribute information about execution of the item to the capture image and storing the capture image, receiving a touch input predefined for the capture image, and executing the item corresponding to the capture image.

According to another aspect of the present invention, a method of controlling a mobile terminal includes displaying a web page on a touchscreen, capturing a screen on which the web page is displayed to generate a capture image, mapping a URL corresponding to the web page to the capture image and storing the capture image, selecting one of capture images stored in a memory, receiving a touch input predefined for the selected capture image, and applying a URL corresponding to the selected capture image to use the capture image as a web page corresponding to the URL.

According to another aspect of the present invention, a method of controlling a mobile terminal includes receiving a capture image mapped to attribute information for executing an item from an external device, receiving a touch input predefined for the capture image, and executing an item corresponding to the capture image on the basis of the attribute information.

According to another aspect of the present invention, a mobile terminal includes a touchscreen, and a controller configured to display one or more items for controlling operations of the mobile terminal on the touchscreen, to capture an image displayed on the touchscreen, to map control functions respectively corresponding to the items to one or more screen capture images generated by capturing the image displayed on the touchscreen and store the screen capture images and, when one of the stored screen capture images is selected, to set an operation state of the mobile terminal according to a control function corresponding to the selected screen capture image.

According to another aspect of the present invention, a mobile terminal includes a communication unit performing data communication with an external device, and a controller configured to receive a screen capture image of the external device through the communication unit and to set an operation state according to at least one control function corresponding to the screen capture image.

According to another aspect of the present invention, a method of controlling a mobile terminal includes displaying one or more items for controlling operations of the mobile terminal on a touchscreen, capturing an image displayed on the touchscreen, mapping the screen capture image to one or more control functions corresponding to the one or more items and storing the screen capture image, and when the screen capture image is selected, setting an operation state of the mobile terminal according to a control function corresponding to the selected screen capture image.

According to another aspect of the present invention, a method of controlling a mobile terminal includes receiving a screen capture image of an external device, and setting an operation state of the mobile terminal according to at least one control function corresponding to the screen capture image.

Details of other embodiments are included in the following detailed description and drawings.

### BRIEF DESCRIPTION OF THE DRAWINGS

The embodiments will be described in detail with reference to the following drawings in which like reference numerals refer to like elements wherein:

FIG. 1 is a block diagram of a mobile terminal according to an embodiment of the present invention;

FIG. 2A is a perspective front view of the mobile terminal according to an embodiment of the present invention;

FIG. 2B is a perspective rear view of the mobile terminal according to an embodiment of the present invention;

FIG. 3 is a flowchart illustrating a method of controlling a mobile terminal according to an embodiment of the present invention;

FIG. 4 is a flowchart of a method of controlling a mobile terminal to illustrate the embodiment shown in FIG. 3 in more detail;

FIGS. 5 to 7 illustrate the embodiment shown in FIG. 4;

FIG. 8 is a flowchart of a method of controlling a mobile terminal to illustrate the embodiment shown in FIG. 3 in more detail;

FIGS. 9 to 11 illustrate the embodiment shown in FIG. 8;

FIG. 12 is a flowchart illustrating a method of controlling a mobile terminal according to an embodiment of the present invention;

FIGS. 13 and 14 illustrate the embodiment shown in FIG. 12;

FIG. 15 is a flowchart illustrating a method of controlling a mobile terminal according to an embodiment of the present invention;

FIGS. 16 and 17 illustrate the embodiment shown in FIG. 15;

FIG. 18 is a flowchart illustrating a method of controlling a mobile terminal according to an embodiment of the present invention;

FIG. 19 illustrates the embodiment shown in FIG. 15;

FIG. 20 is a flowchart illustrating a method of controlling a mobile terminal according to an embodiment of the present invention;

FIGS. 21 to 24 illustrate the embodiment shown in FIG. 20;

FIG. 25 is a flowchart illustrating a method of controlling a mobile terminal according to an embodiment of the present invention;

FIGS. 26 to 28 illustrate the embodiment shown in FIG. 25;

FIG. 29 is a flowchart illustrating a method of controlling a mobile terminal according to an embodiment of the present invention;

FIG. 30 illustrates the embodiment shown in FIG. 29;

FIG. 31 illustrates an example of displaying a capture image according to a method of controlling a mobile terminal according to an embodiment of the present invention;

FIG. 32 is a flowchart illustrating a method of controlling a mobile terminal according to an embodiment of the present invention;

FIGS. 33 and 34 illustrate the embodiment shown in FIG. 32;

FIGS. 35 and 36 illustrate examples of accessing an application to execute a method of controlling a mobile terminal according to an embodiment of the present invention;

FIGS. 37 and 38 illustrate examples of setting a target capture area according to a method of controlling a mobile terminal according to an embodiment of the present invention;

FIG. 39 is a flowchart illustrating a method of controlling a mobile terminal according to an embodiment of the present invention;

FIG. 40 illustrates the embodiment shown in FIG. 39;

FIG. 41 is a flowchart illustrating a method of controlling a mobile terminal according to an embodiment of the present invention;

FIG. 42 illustrates the embodiment shown in FIG. 41;

FIG. 43 is a flowchart illustrating a method of controlling a mobile terminal according to an embodiment of the present invention; and

FIGS. 44 and 45 illustrate the embodiment shown in FIG. 43.

### DETAILED DESCRIPTION

Embodiments may now be described more fully with reference to the accompanying drawings, in which exemplary embodiments of the invention are shown. The invention may, however, be embodied in many different forms and should not be construed as being limited to the embodiments set forth herein; rather, there embodiments are provided so that this disclosure will be thorough and complete, and will fully convey the concept of the invention to those skilled in the art.

A mobile terminal relating to the present invention may be described below in more detail with reference to the accompanying drawings. In the following description, suffixes “module” and “unit” are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system and so on.

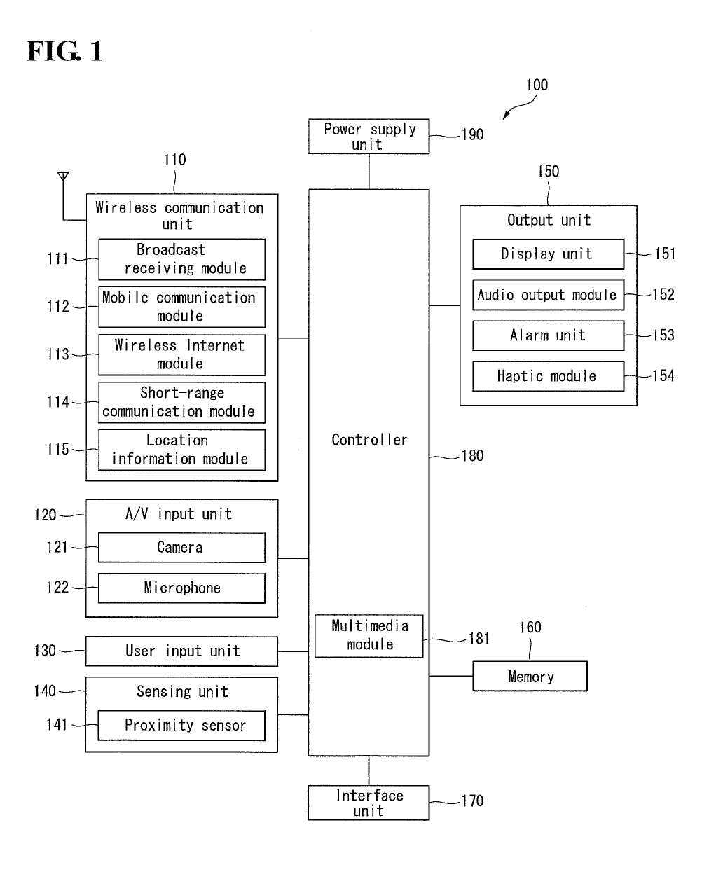

FIG. 1 is a block diagram of a mobile terminal 100 according to an embodiment of the present invention. As shown, the mobile terminal 100 includes a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile terminal as having various components, but implementing all of the illustrated components is not a requirement. Greater or fewer components may alternatively be implemented.

In addition, the wireless communication unit 110 generally includes one or more components allowing radio communication between the mobile terminal 100 and a wireless communication system or a network in which the mobile terminal is located. For example, in FIG. 1, the wireless communication unit includes at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server via a broadcast channel. Further, the broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

In addition, the broadcast associated information may refer to information associated with a broadcast channel, a broadcast program or a broadcast service provider. The broadcast associated information may also be provided via a mobile communication network and, in this instance, the broadcast associated information may be received by the mobile communication module 112.

Further, the broadcast signal may exist in various forms. For example, the broadcast signal may exist in the form of an electronic program guide (EPG) of the digital multimedia broadcasting (DMB) system, and electronic service guide (ESG) of the digital video broadcast-handheld (DVB-H) system, and the like.

The broadcast receiving module 111 may also be configured to receive signals broadcast by using various types of broadcast systems. In particular, the broadcast receiving module 111 can receive a digital broadcast using a digital broadcast system such as the multimedia broadcasting-terrestrial (DMB-T) system, the digital multimedia broadcasting- satellite (DMB-S) system, the digital video broadcast-handheld (DVB-H) system, the data broadcasting system known as the media forward link only (MediaFLO®), the integrated services digital broadcast-terrestrial (ISDB-T) system, etc.

The broadcast receiving module 111 can also be configured to be suitable for all broadcast systems that provide a broadcast signal as well as the above-mentioned digital broadcast systems. In addition, the broadcast signals and/or broadcast-associated information received via the broadcast receiving module 111 may be stored in the memory 160.

In addition, the mobile communication module 112 transmits and/or receives radio signals to and/or from at least one of a base station, an external terminal and a server. Such radio signals may include a voice call signal, a video call signal or various types of data according to text and/or multimedia message transmission and/or reception.

The wireless Internet module 113 supports wireless Internet access for the mobile terminal and may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

Further, the short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

Also, the location information module 115 is a module for checking or acquiring a location or position of the mobile terminal. The location information module 115 may acquire location information by using a global navigation satellite system (GNSS). Here, the GNSS is a standard generic term for satellite navigation systems revolving around the earth and allowing certain types of radio navigation receivers to transmit reference signals determining their location on or in the vicinity of the surface of the earth. The GNSS may include the United States' global positioning system (GPS), the European Union's Galileo positioning system, the Russian global orbiting navigational satellite system (GLONASS), COMPASS, a compass navigation system, by the People's Republic of China, and the quasi-zenith satellite system (QZSS) by Japan.

An example of GNSS is a GPS (Global Positioning System) module. The GPS module may calculate information related to the distance from one point (entity) to three or more satellites and information related to time at which the distance information was measured, and applies trigonometry to the calculated distance, thereby calculating three-dimensional location information according to latitude, longitude, and altitude with respect to the one point (entity). In addition, a method of acquiring location and time information by using three satellites and correcting an error of the calculated location and time information by using another one satellite may be also used. The GPS module may also continuously calculate the current location in real time and also calculate speed information by using the continuously calculated current location.

With reference to FIG. 1, the A/V input unit 120 is configured to receive an audio or video signal, and includes a camera 121 and a microphone 122. The camera 121 processes image data of still pictures or video obtained by an image capture device in a video capturing mode or an image capturing mode, and the processed image frames can then be displayed on a display unit 151.

Further, the image frames processed by the camera 121 may be stored in the memory 160 or transmitted via the wireless communication unit 110. Two or more cameras 121 may also be provided according to the configuration of the mobile terminal.

In addition, the microphone 122 can receive sounds via a microphone in a phone call mode, a recording mode, a voice recognition mode, and the like, and can process such sounds into audio data. The processed audio data may then be converted for output into a format transmittable to a mobile communication base station via the mobile communication module 112 for the phone call mode. The microphone 122 may also implement various types of noise canceling (or suppression) algorithms to cancel or suppress noise or interference generated when receiving and transmitting audio signals.

Also, the user input unit 130 can generate input data from commands entered by a user to control various operations of the mobile terminal. The user input unit 130 may include a keypad, a dome switch, a touch pad (e.g., a touch sensitive member that detects changes in resistance, pressure, capacitance, etc. due to being contacted), a jog wheel, a jog switch, and the like.

Further, the sensing unit 140 detects a current status of the mobile terminal 100 such as an opened or closed state of the mobile terminal 100, a location of the mobile terminal 100, the presence or absence of user contact with the mobile terminal 100, the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. In FIG. 1, the sensing unit 140 also includes a proximity sensor 141.

In addition, the output unit 150 is configured to provide outputs in a visual, audible, and/or tactile manner. In the example in FIG. 1, the output unit 150 includes the display unit 151, an audio output module 152, an alarm unit 153, a haptic module 154, and the like. In more detail, the display unit 151 can display information processed in the mobile terminal 100. For example, when the mobile terminal 100 is in a phone call mode, the display unit 151 can display a User Interface (UI) or a Graphic User Interface (GUI) associated with a call or other communication.

The display unit 151 may also include at least one of a Liquid Crystal Display (LCD), a Thin Film Transistor-LCD (TFT-LCD), an Organic Light Emitting Diode (OLED) display, a flexible display, a three-dimensional (3D) display, or the like. Some of these displays may also be configured to be transparent or light-transmissive to allow for viewing of the exterior, which is called transparent displays.

An example transparent display is a TOLED (Transparent Organic Light Emitting Diode) display, or the like. A rear structure of the display unit 151 may be also light- transmissive. Through such configuration, the user can view an object positioned at the rear side of the terminal body through the region occupied by the display unit 151 of the terminal body.

Further, the mobile terminal 100 may include two or more display units according to its particular desired embodiment. For example, a plurality of display units may be separately or integrally disposed on one surface of the mobile terminal, or may be separately disposed on mutually different surfaces.

Meanwhile, when the display unit 151 and a sensor (referred to as a ‘touch sensor’, hereinafter) for detecting a touch operation are overlaid in a layered manner to form a touch screen, the display unit 151 can function as both an input device and an output device. The touch sensor may have a form of a touch film, a touch sheet, a touch pad, and the like.

Further, the touch sensor may be configured to convert pressure applied to a particular portion of the display unit 151 or a change in the capacitance or the like generated at a particular portion of the display unit 151 into an electrical input signal. The touch sensor may also be configured to detect the pressure when a touch is applied, as well as the touched position and area.

When there is a touch input with respect to the touch sensor, corresponding signals are transmitted to a touch controller, and the touch controller processes the signals and transmits corresponding data to the controller 180. Accordingly, the controller 180 can recognize which portion of the display unit 151 has been touched.

With reference to FIG. 1, the proximity sensor 141 may be disposed within or near the touch screen. In more detail, the proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and can be utilized for various purposes.

Examples of the proximity sensor 141 include a transmission type photoelectric sensor, a direct reflection type photoelectric sensor, a mirror-reflection type photo sensor, an RF oscillation type proximity sensor, a capacitance type proximity sensor, a magnetic proximity sensor, an infrared proximity sensor, and the like. When the touch screen is the capacitance type, proximity of the pointer is detected by a change in electric field according to the proximity of the pointer. In this instance, the touch screen (touch sensor) may be classified as a proximity sensor.

In the following description, for the sake of brevity, recognition of the pointer positioned to be close to the touch screen will be called a ‘proximity touch’, while recognition of actual contacting of the pointer on the touch screen will be called a ‘contact touch’. Further, when the pointer is in the state of the proximity touch, it means that the pointer is positioned to correspond vertically to the touch screen.

By employing the proximity sensor 141, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be output to the touch screen.

Further, the audio output module 152 can convert and output as sound audio data received from the wireless communication unit 110 or stored in the memory 160 in a call signal reception mode, a call mode, a record mode, a voice recognition mode, a broadcast reception mode, and the like. Also, the audio output module 152 can provide audible outputs related to a particular function performed by the mobile terminal 100 (e.g., a call signal reception sound, a message reception sound, etc.). The audio output module 152 may also include a speaker, a buzzer, or the like. In addition, the audio output module 152 may output a sound through an earphone jack.

In addition, the alarm unit 153 can output information about the occurrence of an event of the mobile terminal 100. Typical events include call reception, message reception, key signal inputs, a touch input etc. In addition to audio or video outputs, the alarm unit 153 can provide outputs in a different manner to inform about the occurrence of an event. For example, the alarm unit 153 can provide an output in the form of vibrations. The video signal or the audio signal may be also output through the display unit 151 or the audio output module 152.

In addition, the haptic module 154 generates various tactile effects the user may feel. One example of the tactile effects generated by the haptic module 154 is vibration. The strength and pattern of the haptic module 154 can also be controlled. For example, different vibrations may be combined to be output or sequentially output.

Besides vibration, the haptic module 154 can generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may also be implemented to allow the user to feel a tactile effect through a muscle sensation such as fingers or arm of the user, as well as transferring the tactile effect through a direct contact. Two or more haptic modules 154 may be provided according to the configuration of the mobile terminal 100.

Further, the memory 160 can store software programs used for the processing and controlling operations performed by the controller 180, or temporarily store data (e.g., a phonebook, messages, still images, video, etc.) that are input or output. In addition, the memory 160 may store data regarding various patterns of vibrations and audio signals output when a touch is input to the touch screen.

The memory 160 may also include at least one type of storage medium including a flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

Also, the interface unit 170 serves as an interface with external devices connected with the mobile terminal 100. For example, the external devices can transmit data to an external device, receive and transmit power to each element of the mobile terminal 100, or transmit internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may also be a chip that stores various types of information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device can be connected with the mobile terminal 100 via a port.

When the mobile terminal 100 is connected with an external cradle, the interface unit 170 can also serve as a passage to allow power from the cradle to be supplied therethrough to the mobile terminal 100 or serve as a passage to allow various command signals input by the user from the cradle to be transferred to the mobile terminal therethrough. Various command signals or power input from the cradle may operate as signals for recognizing that the mobile terminal is properly mounted on the cradle.

In addition, the controller 180 controls the general operations of the mobile terminal. For example, the controller 180 performs controlling and processing associated with voice calls, data communications, video calls, and the like. In the example in FIG. 1, the controller 180 also includes a multimedia module 181 for reproducing multimedia data. The multimedia module 181 may be configured within the controller 180 or may be configured to be separated from the controller 180. The controller 180 can also perform a pattern recognition processing to recognize a handwriting input or a picture drawing input performed on the touch screen as characters or images, respectively.

Also, the power supply unit 190 receives external power or internal power and supplies appropriate power required for operating respective elements and components under the control of the controller 180. Further, various embodiments described herein may be implemented in a computer-readable or its similar medium using, for example, software, hardware, or any combination thereof.

For a hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For a software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

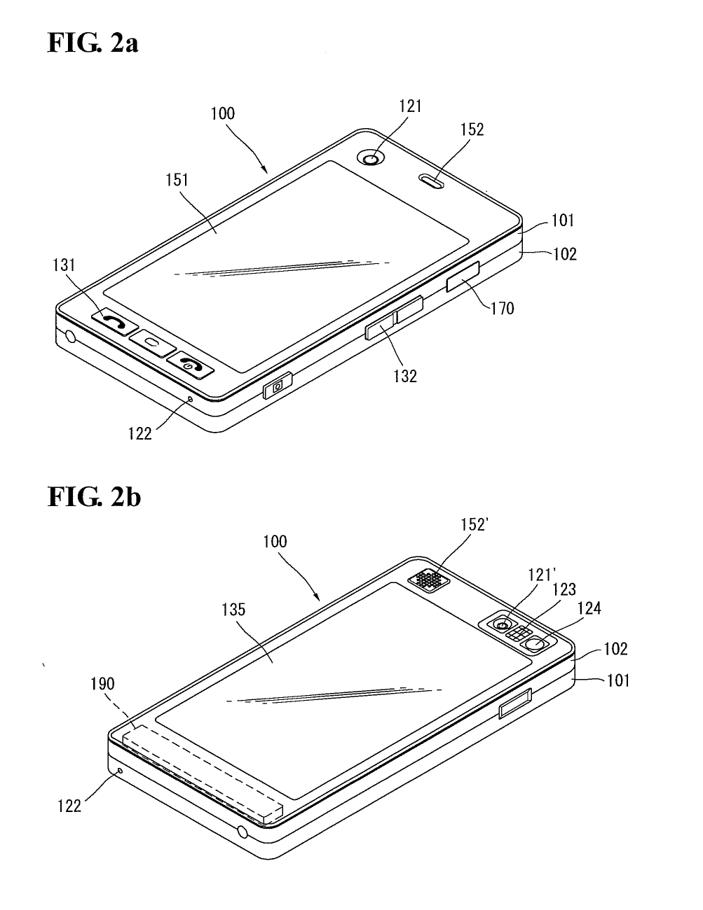

FIG. 2A is a front perspective view of a mobile terminal or a handheld terminal 100 according to an embodiment of the present invention.

The handheld terminal 100 has a bar type terminal body. However, the present invention is not limited to a bar type terminal and can be applied to terminals of various types including slide type, folder type, swing type and swivel type terminals having at least two bodies that are relatively movably combined.

The terminal body includes a case (a casing, a housing, a cover, etc.) forming the exterior of the terminal 100. In the present embodiment, the case can be divided into a front case 101 and a rear case 102. Various electronic components are arranged in the space formed between the front case 101 and the rear case 102. At least one middle case can be additionally arranged between the front case 101 and the rear case 102.

The cases can be formed of plastics through injection molding or made of a metal material such as stainless steel (STS) or titanium (Ti).

The display unit 151, the audio output unit 152, the camera 121, the user input unit 130/131 and 132, the microphone 122 and the interface 170 can be arranged in the terminal body, specifically, in the front case 101.

The display unit 151 occupies most part of the main face of the front case 101. The audio output unit 152 and the camera 121 are arranged in a region in proximity to one of both ends of the display unit 151 and the user input unit 131 and the microphone 122 are located in a region in proximity to the other end of the display unit 151. The user input unit 132 and the interface 170 are arranged on the sides of the front case 101 and the rear case 102.

The user input unit 130 is operated to receive commands for controlling the operation of the handheld terminal 100 and can include a plurality of operating units 131 and 132. The operating units 131 and 132 can be referred to as manipulating portions and employ any tactile manner in which a user operates the operating units 131 and 132 while having tactile feeling.

First and second operating units 131 and 132 can receive various inputs. For example, the first operating unit 131 receives commands such as start, end and scroll and the second operating unit 132 receives commands such as control of the volume of sound output from the audio output unit 152 or conversion of the display unit 151 to a touch recognition mode.

FIG. 2B is a rear perspective view of the handheld terminal shown in FIG. 2A according to an embodiment of the present invention.

Referring to FIG. 2A, a camera 121′ can be additionally attached to the rear side of the terminal body, that is, the rear case 102. The camera 121′ has a photographing direction opposite to that of the camera 121 shown in FIG. 2A and can have pixels different from those of the camera 121 shown in FIG. 2A.

For example, it is desirable that the camera 121 has low pixels such that it can capture an image of the face of a user and transmit the image to a receiving part in case of video telephony while the camera 121′ has high pixels because it captures an image of a general object and does not immediately transmit the image in many cases. The cameras 121 and 121′ can be attached to the terminal body such that they can be rotated or pop-up.

A flash bulb 123 and a mirror 124 are additionally arranged in proximity to the camera 121′. The flash bulb 123 lights an object when the camera 121′ takes a picture of the object. The mirror 124 is used for the user to look at his/her face in the mirror when the user wants to self-photograph himself/herself using the camera 121′.

An audio output unit 152′ can be additionally provided on the rear side of the terminal body. The audio output unit 152′ can achieve a stereo function with the audio output unit 152 shown in FIG. 2A and be used for a speaker phone mode when the terminal is used for a telephone call.

A broadcasting signal receiving antenna 124 can be additionally attached to the side of the terminal body in addition to an antenna for telephone calls. The antenna 124 constructing a part of the broadcasting receiving module 111 shown in FIG. 1 can be set in the terminal body such that the antenna 124 can be pulled out of the terminal body.

The power supply 190 for providing power to the handheld terminal 100 is set in the terminal body. The power supply 190 can be included in the terminal body or detachably attached to the terminal body.

A touch pad 135 for sensing touch can be additionally attached to the rear case 102. The touch pad 135 can be of a light transmission type as the display unit 151. In this case, if the display unit 151 outputs visual information through both sides thereof, the visual information can be recognized through the touch pad 135. The information output through both sides of the display unit 151 can be controlled by the touch pad 135. Otherwise, a display is additionally attached to the touch pad 135 such that a touch screen can be arranged even in the rear case 102.

The touch pad 135 operates in connection with the display unit 151 of the front case 101. The touch pad 135 can be located in parallel with the display unit 151 behind the display unit 151. The touch panel 135 can be identical to or smaller than the display unit 151 in size.

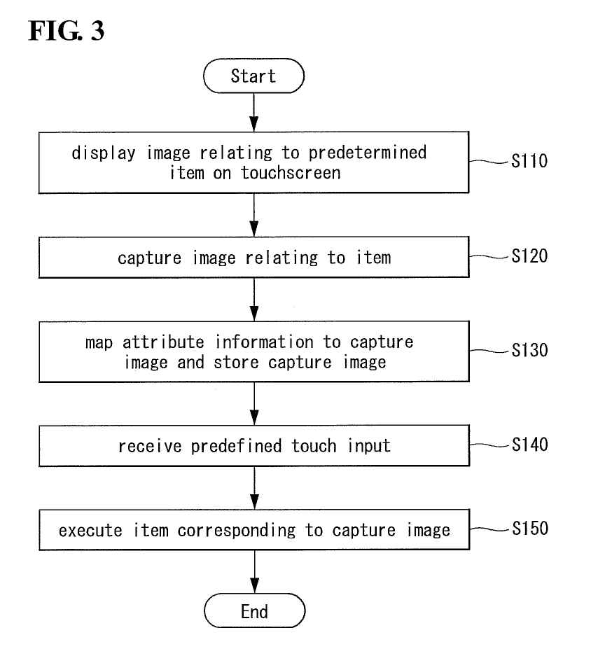

FIG. 3 is a flowchart illustrating a method of controlling a mobile terminal according to an embodiment of the present invention.

Referring to FIG. 3, the controller 180 of the mobile terminal 100 may display an image relating to a predetermined specific item on the touchscreen (S110).

The predetermined specific item may include at least one of an application, music file, video, game, camera and web browser.

The image relating to the specific item may include at least one of a music file play image, a video play image, a game execution image, a camera mode execution image, at least one application execution image, and a web browser execution image.

The image relating to the specific item may include an image with respect to execution of the item.

For example, if the specific item is a music file, the image relating to the specific item can include an album image relating to the music file and description information about played music, which are displayed when the music file is played.

If the specific item is a web browser, the image relating to the item can be a web page image displayed on the touchscreen 151 when the web browser is executed.

The controller 180 may capture the image relating to the item (S120).

The controller 180 may capture the image relating to the item when receiving an image capture input with respect to the image relating to the item.

The image capture input may be input as a predetermined touch pattern to the touchscreen 151. For example, the touch pattern can be a long touch input according to multiple touches corresponding to first and second touch inputs simultaneously applied to the touchscreen 151 for a predetermined time. That is, the touch pattern may be multiple touch inputs that are simultaneously input by two fingers of a user and may be a long touch input.

The image capture input may be a touch input to a predetermined soft key displayed on a region of the touchscreen 151. The image capture input may capture an image by an input to a soft key, an input to a hard key a touch gesture on the touchscreen 151 and/or a motion of the terminal.

The image capture input for performing the image capture operation is not limited to the above-described example, and may vary in various manners. For example, the image capture input may be an input to a predetermined hard key included in a housing of the mobile terminal 100. For example, the image capture input can include an input according to a combination of the first operating unit 131 and/or the second operating unit 132 shown in FIG. 2A.

The controller 180 may map attribute information to the captured image, and the controller 180 may store (or associate) the capture image map to the attribute information (S130). The captured image may also be called a capture image.

The attribute information may be information to execute the item whose image is captured. For example, if a web page is captured, a URL corresponding to the web page may be attribute information of the captured image.

For example, if an external object is captured through a camera, location information corresponding to the captured object can be mapped to the captured image and stored as attribute information.

The controller 180 may execute the specific item corresponding to the captured image of the image relating to the item through only the captured image using the attribute information mapped to the capture image, rather than directly executing the specific item.

The controller 180 may map attribute information about the specific item to the captured image and store the attribute information mapped to the captured image in the memory 160 when the image relating to the specific item is captured.

The memory 160 may store one or more captured images. Upon reception of a touch input predefined for a captured image mapped to the attribute information from among the captured images stored in the memory 160 (S140), the controller 180 may execute the item corresponding to the captured image (S150).

For example, if the captured image corresponds to a specific web page, when a double tapping input is received with respect to the captured image, the controller 180 may use the captured image as a web page rather than a simple image based on attribute information (URL) mapped to the captured image.

Accordingly, the web page may be scrolled according to a scroll operation applied to the touchscreen 151 after the double tapping input is received.

An operation of capturing an image relating to a specific item displayed on the touchscreen 151, mapping attribute information about the specific item to the captured image and storing the attribute information mapped to the capture image to access the item more conveniently using the captured image has been described in the above embodiment.

A description may not be provided of an embodiment when the captured image is a web page.

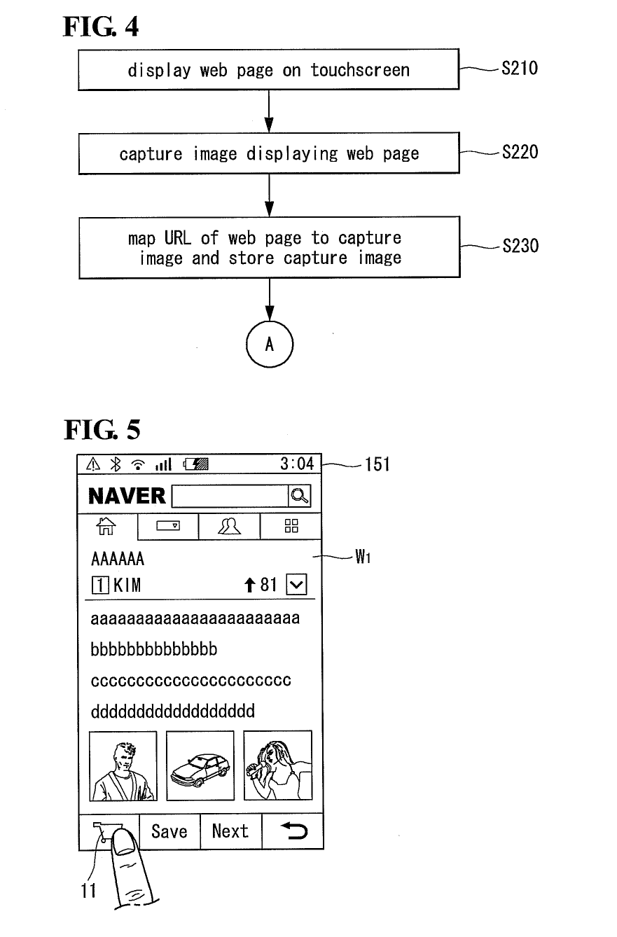

FIG. 4 is a flowchart of a method of controlling the mobile terminal to describe the embodiment shown in FIG. 3. FIGS. 5 to 7 illustrate the embodiment shown in FIG. 4. The method of controlling the mobile terminal may be performed under the control of the controller 180. Other embodiments and configurations may also be provided.

Referring to FIG. 4, the controller 180 of the mobile terminal 100 may display a web page on the touchscreen 151 (S210) and capture an image displaying the web page upon reception of a predetermined image capture input (S220).

The controller 180 may map the URL of the web page to the capture image and store the capture image with the URL (S230).

Referring to FIG. 5, the controller 180 may execute an application capable of executing a web browser and display a predetermined web page (NAVER) W1 on the touchscreen 151.

The controller 180 may capture the web page image to generate a captured image upon reception of an image capture input. The image capture input may be an input to a predetermined soft key displayed on the touchscreen 151.

According to an embodiment of the present invention, the image capture input may correspond to a capture operation of mapping predetermined attribute information to the captured image in addition to capturing an image displayed on the touchscreen 151.

Accordingly, the controller 180 may provide a predetermined image capture icon 11 to a region (e.g. a control region for controlling items displayed on the touchscreen 151) in order to generate the captured image of the web page, to which the attribute information (URL) is mapped. The image capture icon 11 may be a graphical object.

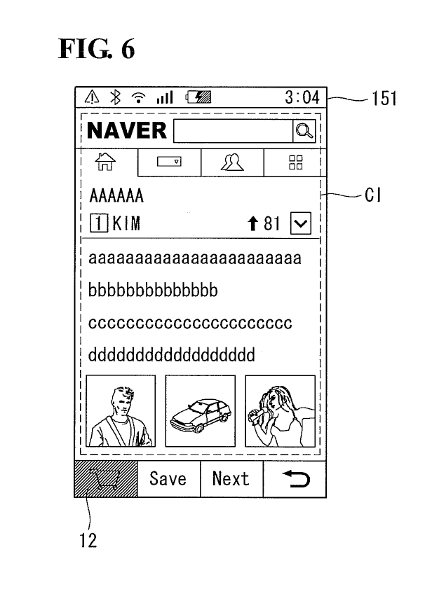

Referring to FIG. 6, the controller 180 may change the visual appearance of the image capture icon 11 when the web page image is captured. Change in the visual appearance of the image capture icon 11 may include changes in the size, color and shape of the graphical object, giving an animation effect to the graphical object, etc.

Accordingly, a user can recognize generation of capture image CI through a change in the visual appearance of the image capture icon. In FIG. 6, reference numeral 12 represents the image capture icon having a changed visual appearance as the mobile terminal 100 performs image capture.

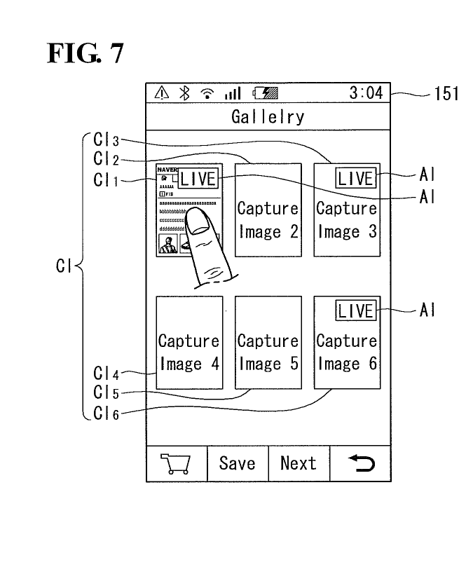

Referring to FIG. 7, the controller 180 may store one or more captured images CI1, CI2, CI3, CI4, CI5 and CI6. These captured images may include captured images to which predetermined attribute information is mapped and captured images to which attribute information is not mapped.

To discriminate the captured images to which attribute information is mapped from the captured images to which attribute information is not mapped, the controller 180 may display an attribute identifier AI for indicating that predetermined attribute information is mapped to captured images on the corresponding capture images and store the capture images with the attribute identifier.

Referring to FIG. 7, to distinguish captured images CI1, CI3 and CI6 to which attribute information is mapped from among a plurality of images stored in a gallery from captured images CI2, CI4 and CI5 to which attribute information is not mapped, the controller 180 can indicate that the captured images CI1, CI3 and CI6 are generated in a capture mode in which attribute information is mapped to the corresponding capture images by displaying an identifier AI “LIVE” on the corresponding captured images.

Accordingly, the controller 180 may map URL information to the web page captured image, display the identifier for indicating that the URL information is mapped to the web page captured image on the captured image and store the captured image with the identifier.

The operation of capturing an image relating to an item displayed on the touchscreen 151, mapping related attribute information to the captured image and storing the captured image with the attribute information has been described in the above embodiment.

A description may not be provided of a method of using a captured image stored according to the above-mentioned method based on attribute information mapped to the captured image.

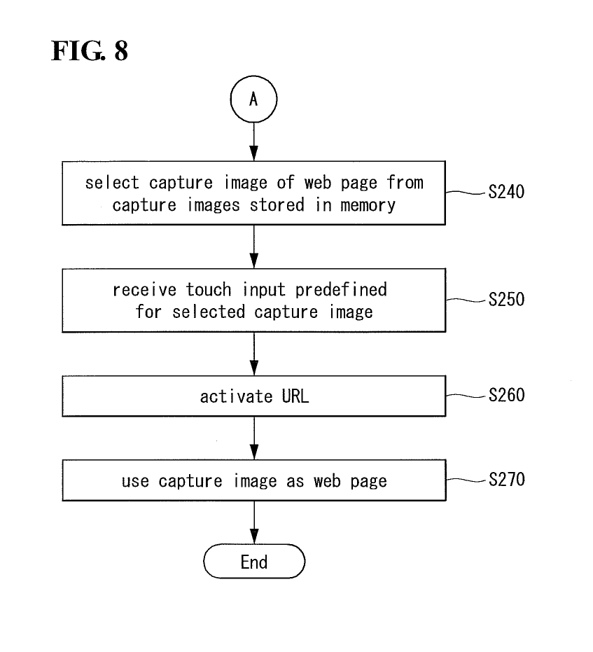

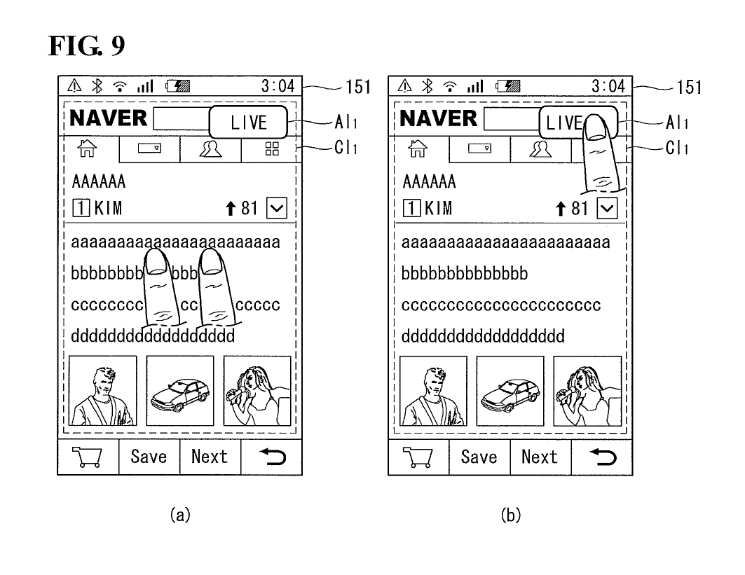

FIG. 8 is a flowchart illustrating a method of controlling the mobile terminal to describe the embodiment shown in FIG. 3. FIGS. 9 to 11 illustrate the embodiment shown in FIG. 8. The method of controlling the mobile terminal may be performed under the control of the controller 180. Other embodiments and configurations may also be provided.

The memory 160 may store a plurality of captured images and the controller 180 may select the above-mentioned captured image of the web page from the captured images stored in the memory 160 (S240).

A predefined touch input for executing the item corresponding to the selected captured image based on the attribute information may be received for the selected captured image (S250).

The predefined touch input may include a touch input related to the identifier or a double tapping input related to the captured image.

The controller 180 may activate the URL corresponding to the attribute information (S260) and use the captured image as the web page (S270) when receiving the double tapping information related to the selected captured image.

Accordingly, it is possible to easily access the web page using the captured image without executing a specific web browser.

Referring to FIG. 9(a), the controller 180 can activate attributed information mapped to the captured image CI1 and use the captured image CI1 as a web page when receiving a double tapping input related to the captured image CI1.

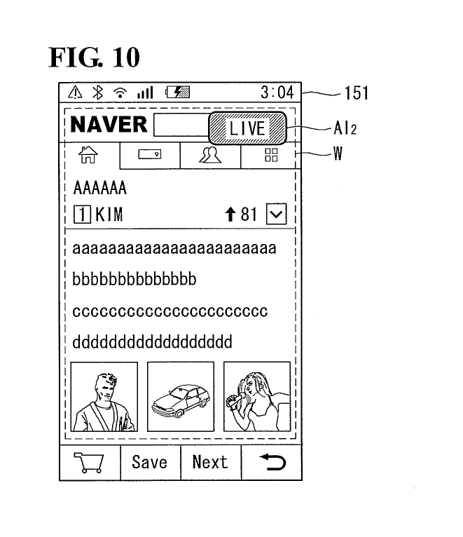

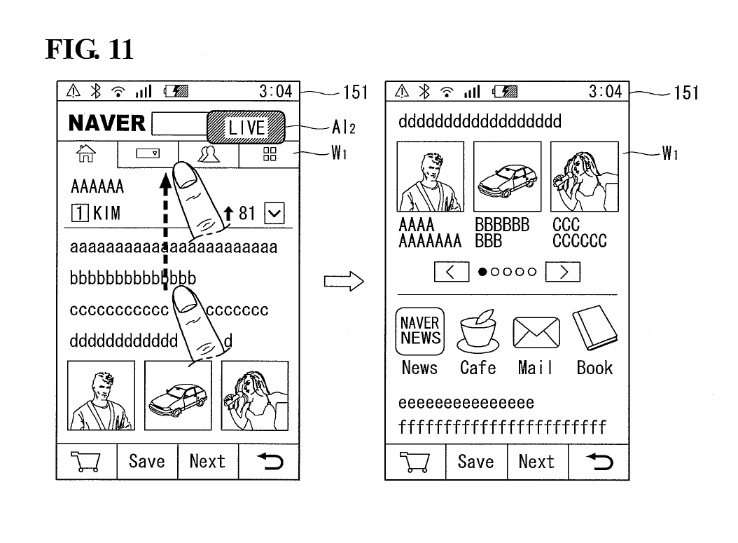

Referring to FIG. 10, upon reception of the double tapping input for the capture image CI1 with an attribute information mapping identifier AI1 displayed thereon, the controller 180 can change the visual appearance of the attribute information mapping identifier AI1. In FIG. 10, an attribute information mapping identifier AI2 may indicated that the visual appearance of the attribute information mapping identifier has been changed. Accordingly, the user can recognize that the attribute of the captured image CI1 does not corresponds to a simple image file and the captured image CI1 can be used as the web page W1.

Referring to FIG. 9(b), the controller 180 can activate the attribute information of the captured image CI1 to use the captured image CI1 as the web page W1 when receiving a touch input for the attribute information mapping identifier AI1.

FIG. 11 illustrates an example of using the captured image as the web page.

Referring to FIG. 11, upon reception of a scroll input for the web page W1, the controller 180 can scroll the web page W1 in response to the scroll input.

To use the captured image as the web page, the controller 180 may change the attribute of the captured image from an image to a web and use the captured image while maintaining the captured image display state without executing an additional web browsing procedure.

While the web page is captured and the attribute information mapped to the captured image is the URL of the web page, embodiments of the present invention are not limited thereto.

For example, the attribute information can be varied and stored according to type, attribute, etc. of a captured target. When the captured target is a web page, the attribute information may include location information about at least one item included in the web page.

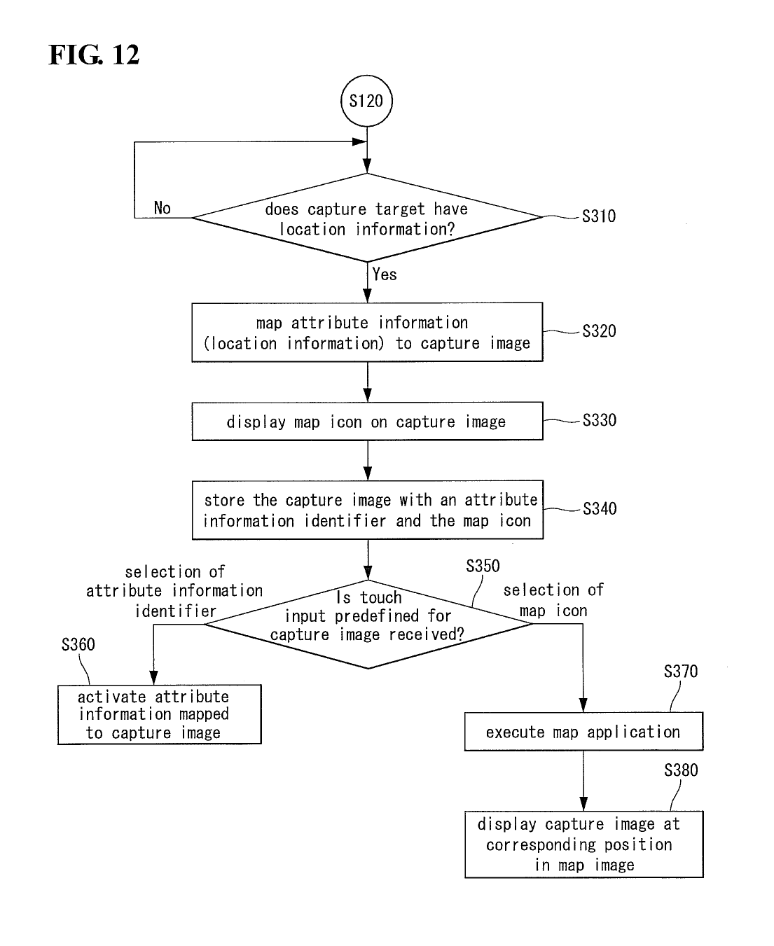

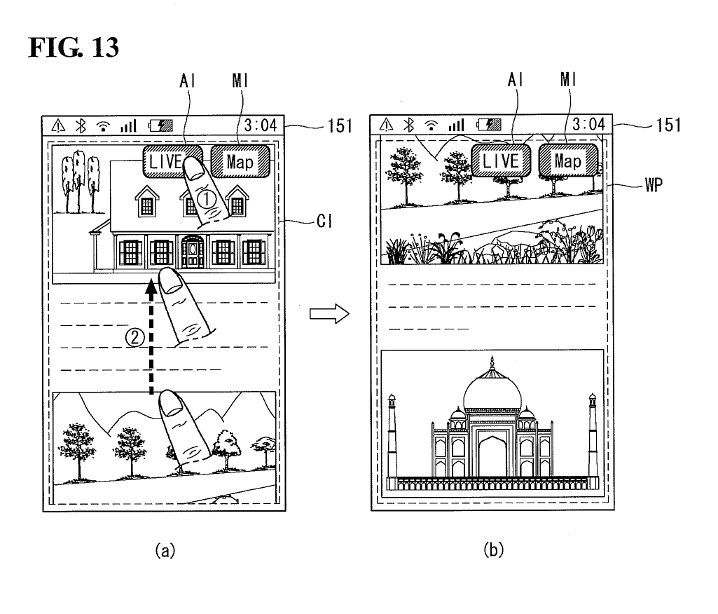

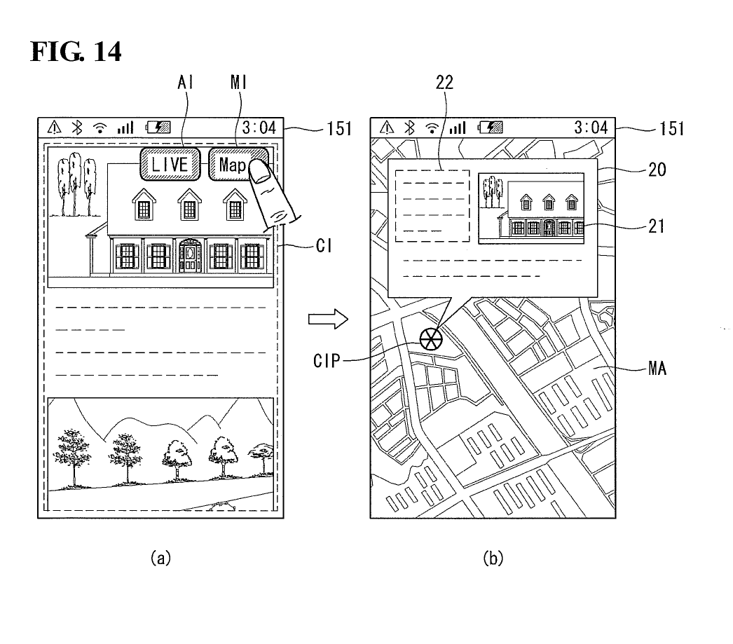

FIG. 12 is a flowchart illustrating a method of controlling the mobile terminal according to an embodiment of the present invention FIGS. 13 and 14 illustrate the embodiment shown in FIG. 12. The method of controlling the mobile terminal may be performed under the control of the controller 180.

According to an embodiment of the present invention, a capture image can be used in various manners according to the type of an item displayed on the touchscreen 151. A description will be given of an example of interworking of a capture image and a map application when attribute information mapped to the capture image includes location information.

Referring to FIG. 12, the controller 180 may check whether a capture target include location information (S310).

For example, if an item displayed on the touchscreen 151 is a web page and the web page image is captured, the capture image may include a predetermined object having location information.

The controller 180 may map the location information to the capture image as attribute information (S320). Otherwise, the controller 180 may map the URL of the web page and location information of an object displayed on the web page to the capture image and store the capture image with the URL and location information.

The controller 180 may display a map icon with the capture image to indicate that the location information has been mapped to the capture image (S330).

The controller 180 may store the capture image with an attribute information identifier and the map icon displayed thereon in the memory 160 (S340).

The controller 180 may receive a predefined touch input for the capture image.

When the predefined touch input is an input for selecting the attribute information identifier displayed on the capture image (S350: selection of attribute information identifier), the controller 180 can activate the attribute information mapped to the capture image.

When the predefined touch input is an input for selecting the map icon displayed on the capture image (S350: selection of map icon), the controller 180 may execute a map application (S370) and display the capture image at a corresponding position in a map image (S380).

The embodiment of FIG. 12 will now be described in more detail with reference to FIGS. 13 and 14.

Referring to FIG. 13, a capture image CI is generated by capturing a web page image (WP), and the web page image includes an item (e.g. a picture) capable of having location information.

Accordingly, the controller 180 can map URL information of the corresponding web page and location information about the item (e.g. a picture including location information) included in the web page to the capture image CI as attribute information and store the capture image CI with the attribute information.

The controller 180 can display an attribute information identifier AI and a map icon MI for indicating that the attribute information is mapped to the capture image CI on the capture image CI and store the capture image CI with the attribute information identifier AI and the map icon MI.

Referring to FIG. 13(a), the controller 180 can activate the attribute information (URL) of the web page to use the capture image CI as the web page upon selection of the attribute information identifier AI. Accordingly, the controller 180 can respond to a scroll input for the capture image CI, as shown in FIG. 13(b).

Referring to FIG. 14(a), the controller 180 can execute the map application MA when the map icon MI is selected, and map the capture image CI to a corresponding position in a map image and display the capture image CI at the position.

A capture image 20 mapped to the map image may include an image file 21, description information 22 about the image file, etc.

A case in which a capture image is an image displayed on the touchscreen 151 of the mobile terminal 100 has been described in the above embodiment. However, the present invention is not limited thereto. For example, the capture image may include an external object image captured through a camera included in the mobile terminal 100.

A description will be given of an example of mapping predetermined attribute information to an image captured through a camera and storing the image with the attribute information.

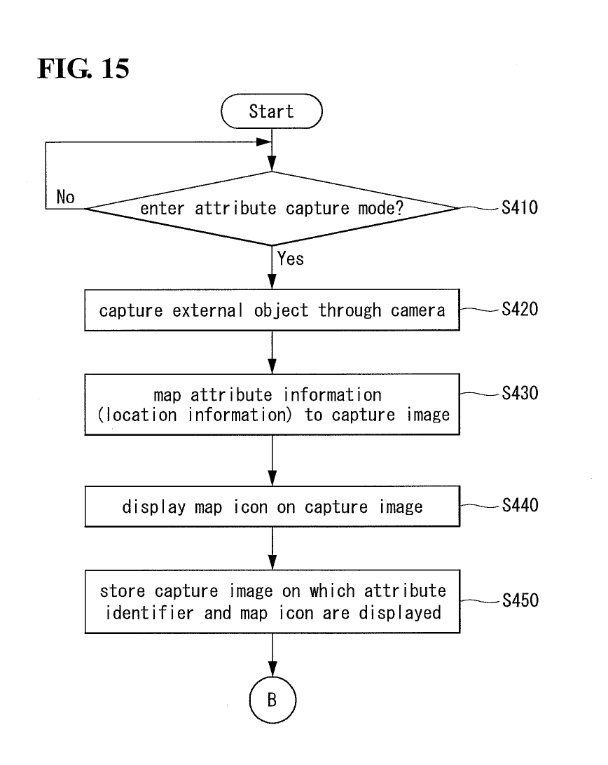

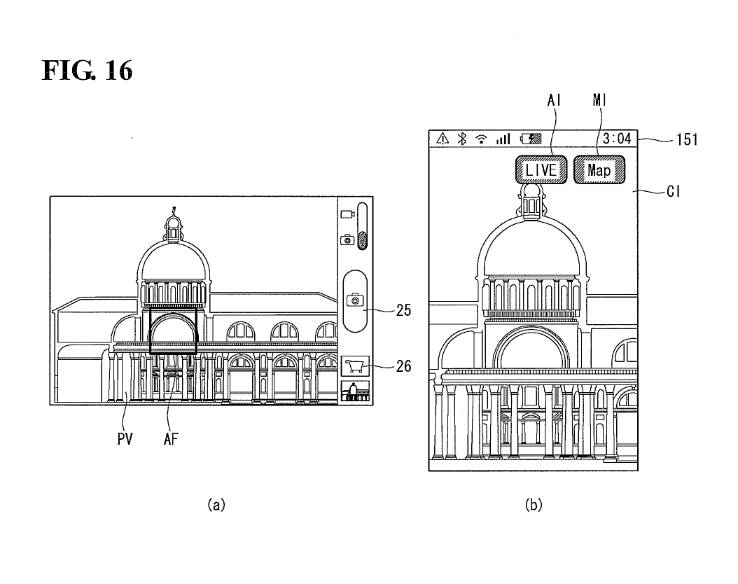

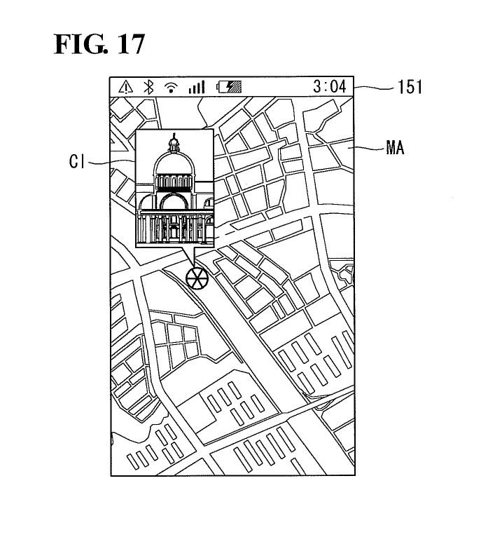

FIG. 15 is a flowchart illustrating a method of controlling the mobile terminal according to an embodiment of the present invention. FIGS. 16 and 17 illustrate the embodiment shown in FIG. 15. The method of controlling the mobile terminal may be performed under the control of the controller 180.

Referring to FIG. 15, the controller 180 may enter an attribute information capture mode (S410: YES).

The mobile terminal 100 may include the camera 121 and capture an external object using the camera 121 (S420).

The controller 180 may map predetermined attribute information to the image captured using the camera 121 and store the capture image with the attribute information in the attribute information capture mode (S430). The attribute information may be location information about a place or an object included in the capture image.

The controller 180 may display a map icon on the capture image (S440).

The controller 180 may store the capture image on which the map icon and an attribute information identifier in the memory 160 (S450).

Referring to FIG. 16(a), the mobile terminal 100 may photograph a predetermined object or place using the camera 121. In FIG. 16(a), PV denotes a preview image and AF denotes an identifier for auto focusing.

When the preview image PV is provided, an image corresponding to the preview image PV is photographed if an image photographing icon 25 is pressed, and the preview image PV is captured if an image capture icon 26 is pressed. Location information about a photographed object may be mapped to the capture image of the object and stored.

Referring to FIG. 16(b), the controller 180 may display the attribute information identifier AI and the map icon MI on a capture image CI photographed through the camera 121 and store the capture image CI with the attribute information identifier AI and the map icon MI.

When the map icon MI is selected, the controller 180 may execute the map application MA and map the capture image CI to a corresponding position in the map image to display the capture image CI at the position, as shown in FIG. 17.

Attribute information mapped to a capture image according to the method of controlling the mobile terminal according to an embodiment of the present invention is related to the attribute of an item corresponding to a capture target, as described above.

The scope of the present invention may include an idea of transmitting a capture image to which attribute information is mapped to an external device and executing an item corresponding to the capture image in the external device.

If the item has digital right management (DRM), attribute information is differently mapped to the capture image. A description will be given of an example of processing an item to which DRM is applied according to an embodiment of the present invention.

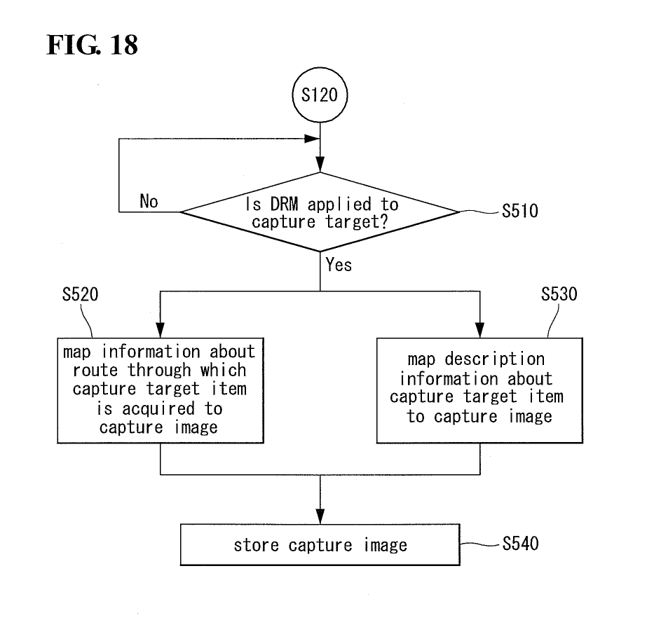

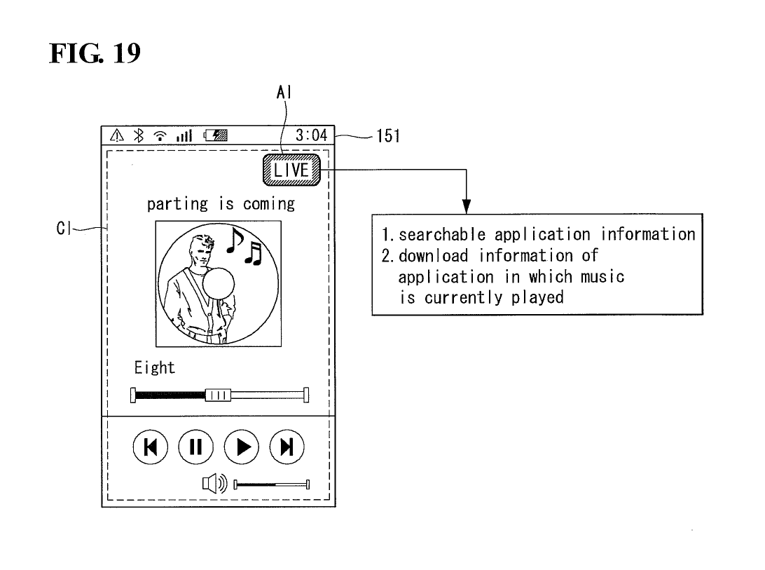

FIG. 18 is a flowchart illustrating a method of controlling the mobile terminal according to an embodiment of the present invention and FIG. 19 illustrates the embodiment shown in FIG. 18. The method of controlling the mobile terminal may be performed under the controller 180.

Referring to FIG. 18, the controller 180 determines whether a capture image includes an item to which DRM is applied (S510).

If the capture image includes the item to which DRM is applied, the controller 180 may map information about a route (e.g. downloadable link information) through which the item can be acquired to the capture image (S520). The controller 180 may map description information about the item to the capture image (S530).

That is, when an image in which an item protected by DRM is played or displayed is captured, attribute information that is related to the item and does not violate DRM can be mapped to the capture image and stored (S540).

Referring to FIG. 19, the controller 180 may display an image related to an item protected by DRM on the touchscreen 151 and capture the image. The controller 180 may display the identifier AI, which indicates that attribute information has been mapped to the capture image, on the capture image CI and store the capture image CI with the attribute information mapping identifier AI.

Here, the attribute information may include at least one of information about an application capable of searching the item and download information about an application executing the item.

For example, if an image displayed on the touchscreen 151 is captured while a music file protected by DRM is played, the controller 180 can map download information about valid download of the music file, instead of the music file, to the capture image and store the capture image with the download information.

Particularly, in the case of an item protected by DRM, a problem may be generated when a capture image related to the item, to which attribute information is mapped, is transmitted from a first mobile terminal to a second mobile terminal and the second mobile terminal executes the item using the received capture image.

A description will be given of an example of sharing a capture image to which attribute information is mapped with another mobile terminal and special handling of an item protected by DRM.

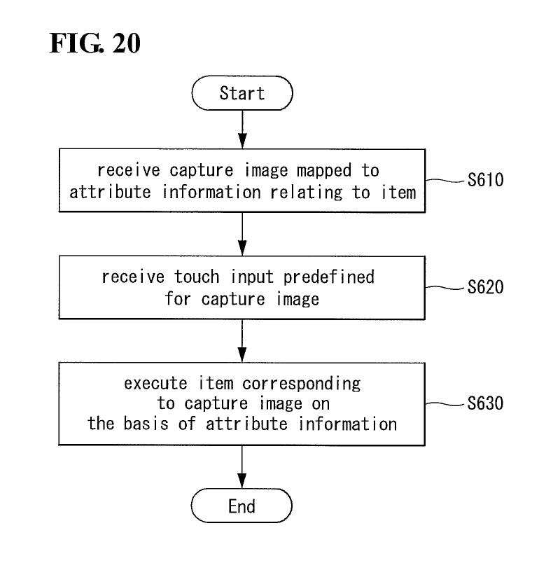

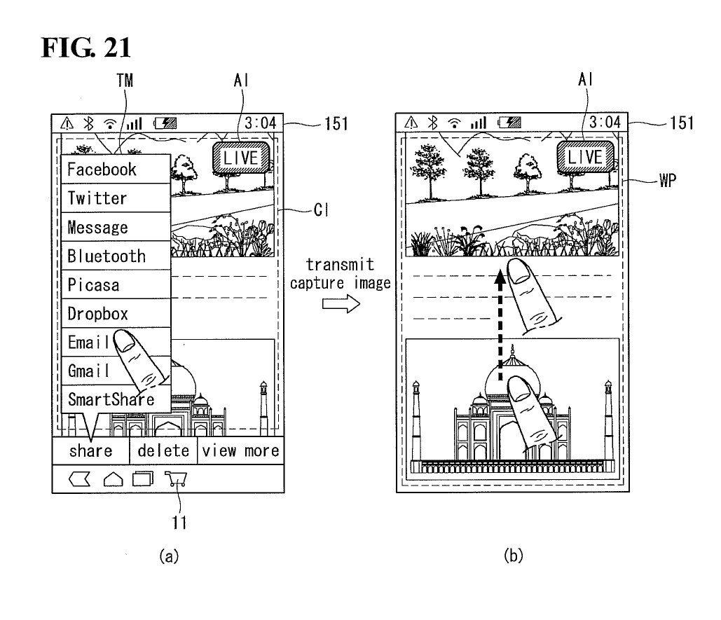

FIG. 20 is a flowchart illustrating a method of controlling the mobile terminal according to an embodiment of the present invention and FIGS. 21 to 24 illustrate the embodiment shown in FIG. 20. The method of controlling the mobile terminal may be performed under the controller 180.

Referring to FIG. 20, the controller 180 may receive a capture image to which attribute information about a predetermined item is mapped from an external terminal (S610).

Upon reception of a predefined touch input (S620), the controller 180 may execute the item corresponding to the capture image on the basis of the attribute information (S630).

That is, when the mobile terminal 100 receives a capture image of a web page, to which URL information of the web page is mapped, the mobile terminal 100 can display the web page corresponding to the capture image on the touchscreen 151 by simply operating the received capture image without executing an additional web browsing procedure.

Accordingly, it is possible to change an attribute of a received image file to a web page and use the web page.

The above embodiment will now be described in more detail with reference to FIGS. 21 to 24.

FIG. 21(a) shows an exemplary screen of the mobile terminal 100 serving as a transmitter, which is displayed to select a means TM for sharing a capture image CI to which attribute information is mapped with an external device and share the capture image CI with the external device through the selected sharing means (e.g. a message or e-mail).

FIG. 21(b) shows an exemplary screen of a mobile terminal 200 serving as a receiver, which uses the capture image received through the selected sharing means from the mobile terminal 100 as a web page WP.

When the mobile terminal 100 serving as a transmitter sends an image, the mobile terminal 200 serving as a receiver can use the received image as a web page using attribute information mapped to the image.

The mobile terminal 200 may receive the capture image to which the attribute information is mapped from the mobile terminal 100 in the form of a pop-up image.

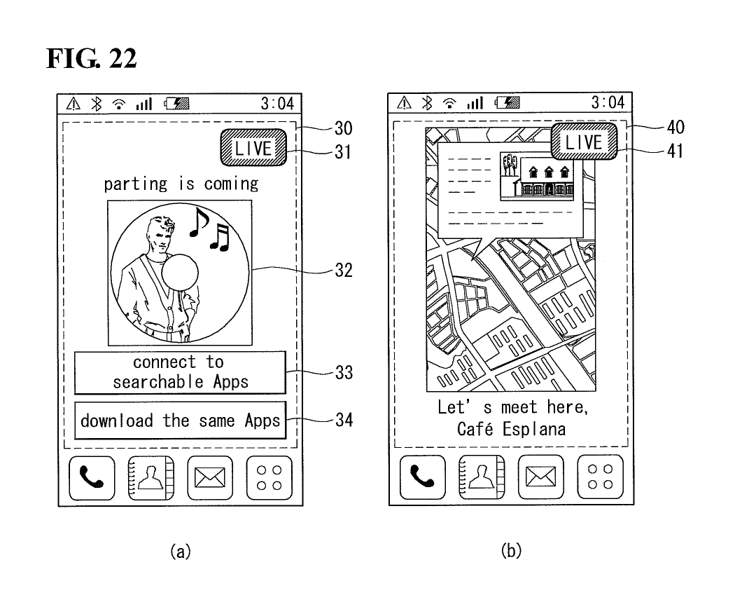

Referring to FIG. 22(a), when a capture image 32 corresponding to an item protected by DRM is received, attribute information including at least one of information 33 on connection to an application capable of searching the item and information 34 on download of an application for executing the item and an identifier (LIVE) 31 indicating that the attribute information has been mapped to the capture image 32 may be provided to a pop-up window 30 and received.

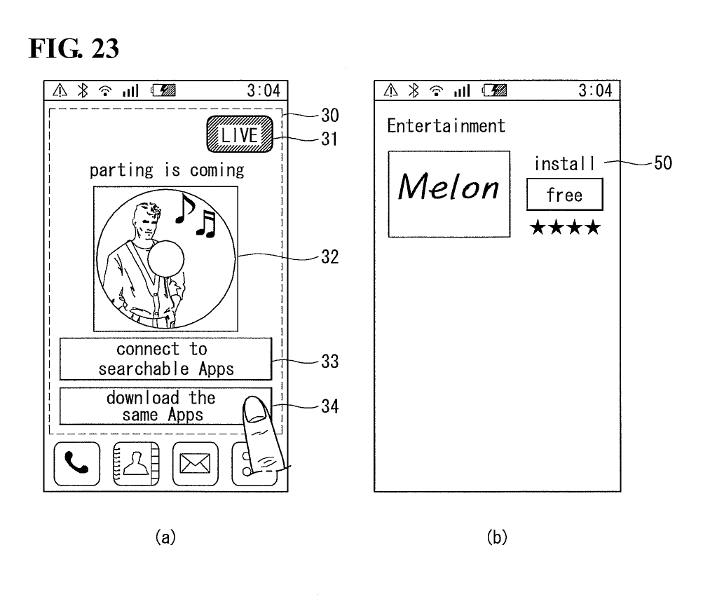

Referring to FIG. 23, it is possible to directly connect to the application capable of searching the item corresponding to the received capture image and to directly access a download link 50 for executing the item through the pop-up window 30.

Referring to FIG. 22(b), when a DRM related problem is not generated (e.g. the receiver mobile terminal 200 receives a capture image to which attribute information is mapped), the receiver mobile terminal 200 may receive an identifier (LIVE) 41 indicating that the attribute information has been mapped to the capture image through a pop-up window 40.

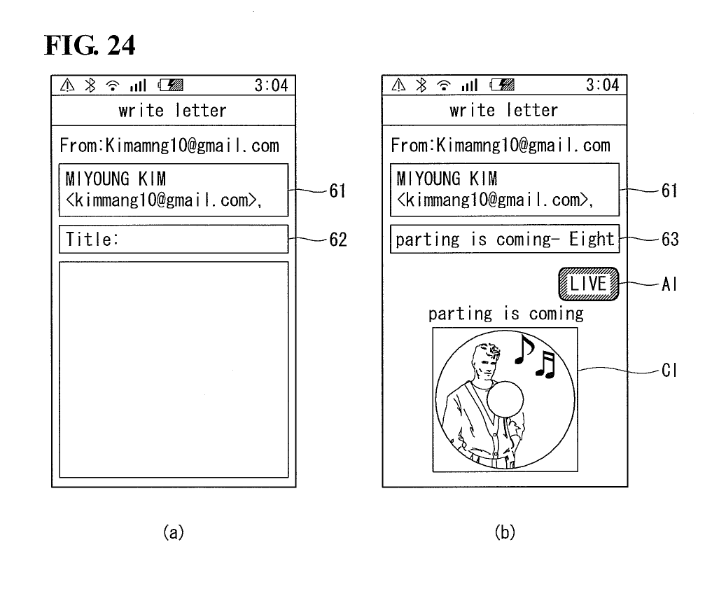

FIG. 24 shows an example of transmitting a capture image to which attribute information is mapped to an external terminal through e-mail according to an embodiment of the present invention.

Referring to FIG. 24(a), the mobile terminal 100 may provide regions in which information 61 about a receiving side and a title 62 are input to transmit e-mail.

According to the method of controlling the mobile terminal according to the present embodiment, when a capture image to which attribute information is mapped is attached to e-mail, the controller 180 can use the attribute information to transmit the e-mail.

For example, the capture image CI on which the identifier (LIVE) AI indicating that the attribute information has been mapped to the capture image CI is displayed can be attached to an e-mail text.

Furthermore, if the item is music, information about the music (e.g. music title, musician, etc.) can be automatically mapped to an e-mail title tap 63.

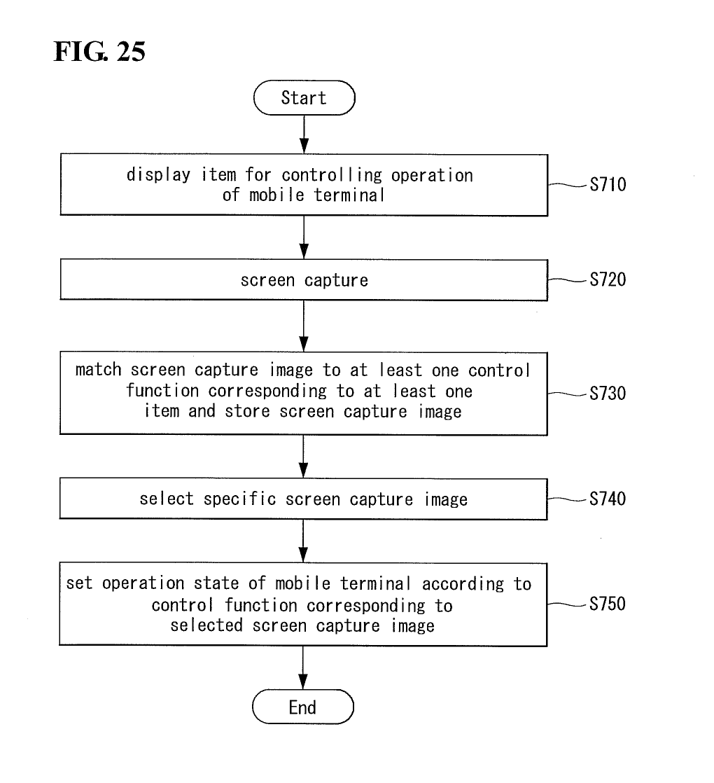

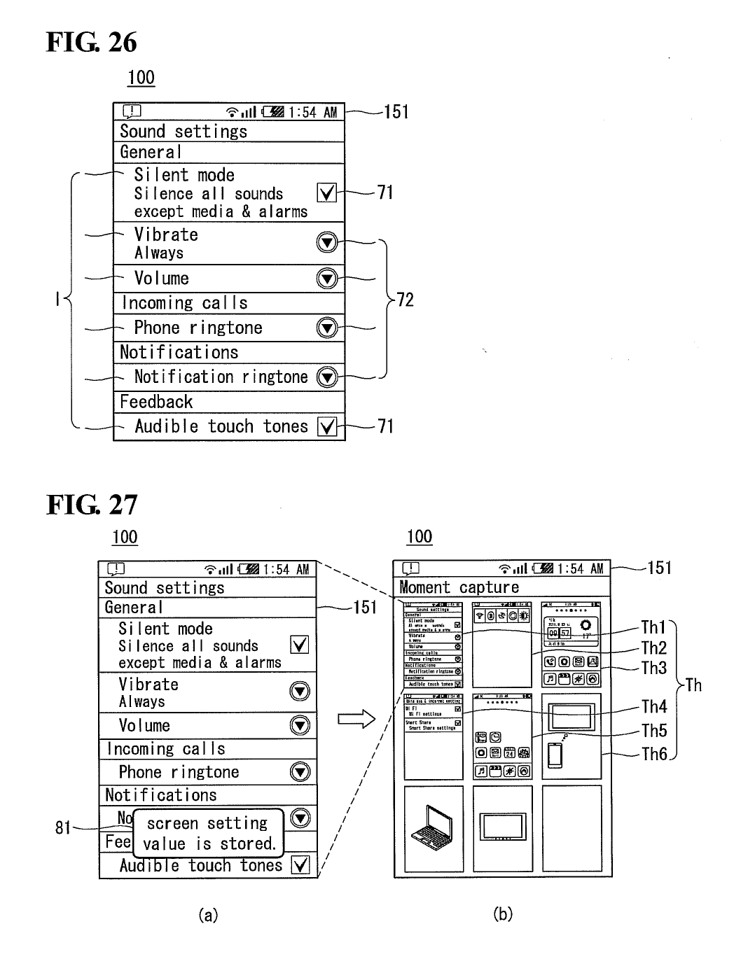

FIG. 25 is a flowchart illustrating a method of controlling the mobile terminal according to an embodiment of the present invention. FIGS. 26 to 28 illustrate the embodiment shown in FIG. 25. The method of controlling the mobile terminal may be performed under the controller 180. Other embodiments and configurations may also be provided.

The controller 180 of the mobile terminal 100 may display items for controlling operations of the mobile terminal 100 on the touchscreen 151 (S710).

The items for controlling operations of the mobile terminal may include setting information for executing internal functions of the mobile terminal 100. The setting information may include call setting information, sound setting information, display setting information, power setting information, location setting information, security setting information, etc.

More specifically, the call setting information may include information about setting of a message to be transmitted after rejection of a received call, Bluetooth headset setting information, international call limitation setting information, call alarm setting information, phone reception mode management setting information, information about setting related to a proximity sensor operation during a call, etc. In the example of call setting, the use may add new setting information.

The items for controlling operations of the mobile terminal may correspond to a list of data. As described above, setting information for controlling operations of the mobile terminal 100 may be provided in the form of a data list.

The controller 180 of the mobile terminal 100 may capture an image information displayed on the touchscreen 151 (S720).

Information displayed on the touchscreen 151 may be one or more lists of data for controlling the mobile terminal 100. The controller 180 may capture an image displaying the data list.

Image capture may be performed according to an operation of at least one of the user input units 130 (131 and 132) shown in FIGS. 2A and 2B. Image capture may also be performed using a predetermined soft key displayed on the touchscreen 151.

The controller 180 may map a control functions corresponding to at least one of the items to a screen capture image and store a mapping result in the memory 160 (S730).

If a plurality of items (e.g. 3 items) are displayed on the touchscreen 151 and different control functions (e.g. 3 different control functions) are respectively set for the items, the controller 180 can map the control functions (3 control functions) respectively corresponding to the items to the screen capture image and store a mapping result.

Accordingly, the mobile terminal 100 may conveniently control operations thereof using one screen capture image mapped to the 3 control functions.

A plurality of screen capture images may be stored in the memory 160. That is, a number of screen capture images may be proportional to a number of displays on the touchscreen 151 and captures.

The controller 180 may receive an input for selecting a specific screen capture image from the screen capture images stored in the memory 160 (S740).

The controller 180 may set an operation state of the mobile terminal 100 according to a control function corresponding to the selected screen capture image (S750).

Accordingly, an operation state of the mobile terminal 100 may be easily changed using a previously stored screen captured image.

The above-mentioned method of controlling the mobile terminal may now be described in more detail with reference to FIGS. 26 to 28.

The controller 180 may display one or more items for controlling operations of the mobile terminal 100 on the touchscreen 151. The items may be provided in the form of a data list (e.g., an environment setting menu).

Referring to FIG. 26, a data list displayed on the touchscreen 151 may be a set I of items for controlling sounds of the mobile terminal 100.

The items for controlling the sounds of the mobile terminal 100 may include a silent mode for processing sounds other than multimedia related sounds or alarm sounds as silent, a vibrate mode for signaling execution of an event generated in the mobile terminal 100, a phone ringtone for an incoming call, a notification ringtone, an audible touch tones, etc.

Reference numeral 71 may represent a selection button for indicating whether a setting related to a corresponding item is selected by the user and reference numeral 72 may represent an identifier for indicating that each item includes at least one item corresponding to a lower category.

Referring to FIG. 27(a), a screen displayed on the touchscreen 151 may be captured, and the controller 180 may display a message 81 indicating that an operation setting value of the mobile terminal 100 (provided through the screen) is mapped to a screen capture image and is stored.

The controller 180 may process the screen capture image into a thumbnail image having a predetermined size and store the thumbnail image. The controller 180 may display a screen including one or more thumbnail images Th1, Th2, Th3, Th4, Th5 and Th6 on the touchscreen 151 (refer to FIG. 27(b)).

Referring to FIG. 27(b), the thumbnail images Th stored in the memory 160 may include various screen captured images. For example, the thumbnail images Th may include thumbnail image Th1 related to normal setting of the mobile terminal 100, thumbnail image Th3 related to home screen setting, thumbnail image Th6 related to setting of connection with an external device, etc.

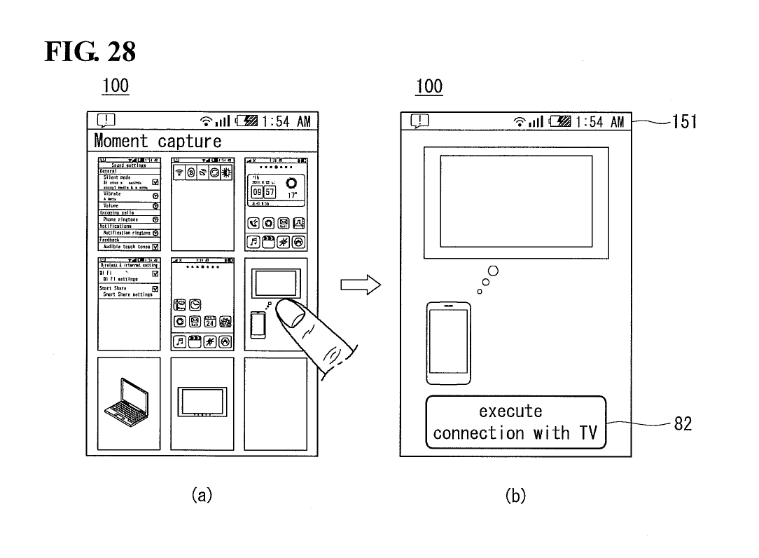

Referring to FIG. 28, when at least one of the stored screen captured images is selected (FIG. 28(a)), the controller 180 may apply a control function corresponding to the captured screen image to the mobile terminal 100 (FIG. 28(b)).

The controller 180 may display a message 82 for signaling that an operation state of the mobile terminal 100 is set on the touchscreen 151 using the screen captured image.

Specifically, the user may set an operation state of the mobile terminal 100 by applying the first thumbnail image Th1 without setting details setting items composed of a plurality of steps. Furthermore, the user may use the third thumbnail image Th3 to set widgets, applications, menu items, etc. arranged on the home screen according to arrangement in the third thumbnail image Th3. In addition, the user may easily set connection with an external device (e.g. a TV receiver) using the sixth thumbnail image Th6.

In at least one embodiment, the mobile terminal (FIG. 28(b)) may display a plurality of captured images. The plurality of captured images may include a captured image from another terminal (such as another mobile terminal). Upon selection of one of the captured images (such as from the other terminal), a message may be displayed that the original mobile terminal can not perform a specific function. Alternatively, one of the displayed captured images that contains a function that can not be performed by the original mobile terminal may be displayed differently than other ones of the captured images that contain function that may be performed.

The mobile terminal 100 may select an item to which a predetermined control function will be mapped from one or more items displayed on the touchscreen 151 through screen capture.

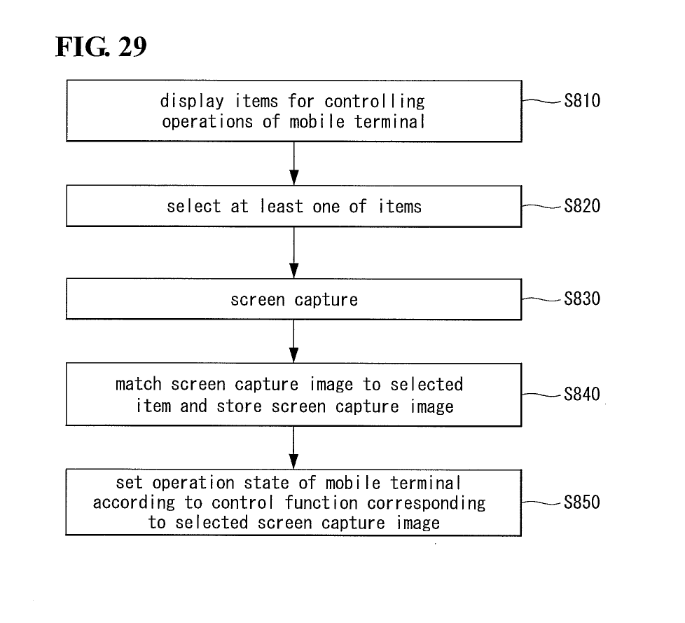

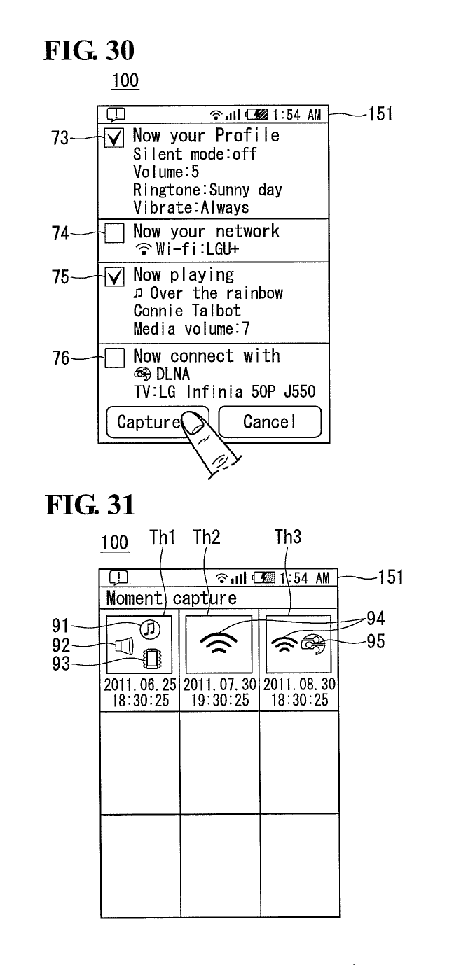

FIG. 29 is a flowchart illustrating a method of controlling the mobile terminal according to an embodiment of the present invention and FIG. 30 illustrates the embodiment of FIG. 29.

Referring to FIG. 29, the controller 180 may display one or more items for controlling operations of the mobile terminal 100 on the touchscreen 151 (S810).

At least one item may be selected from the displayed items (S820) and screen capture may be performed (S830).

A screen capture image may be matched to a control function corresponding to the selected item and stored (S840).

Referring to FIG. 30, control functions corresponding to items 73 and 75 may be set for the mobile terminal 100 through thumbnail images according to screen capture, from among control items 73, 74, 75 and 76 for controlling the mobile terminal 100.

Accordingly, a target that can be set through the screen capture image can be previously selected by the user even when the screen shown in FIG. 30 is captured. In a capture image of the screen shown in FIG. 30, control functions corresponding to items 74 and 76 are not matched and only control functions corresponding to items 73 and 75 are mapped and stored.

The controller 180 may set an operation state of the mobile terminal 100 according to the control function corresponding to the selected screen capture image (S850).

For example, if a screen capture image corresponding to the screen shown in FIG. 30 is stored and the stored screen capture image is selected, a Wi-Fi setting item (item 74) for wireless network connection and a DLNA network setting item (item 76) are not applied.

FIG. 31 shows an example of displaying a screen capture image according to a method of controlling the mobile terminal according to an embodiment of the present invention.

Referring to FIG. 31, the controller 180 may map a predetermined control function to a screen capture image and store the screen capture image with the control function in the form of a thumbnail image in the memory 160.

The thumbnail image may include an identifier for identifying the control function.

For example, a screen capture image stored on 25 Jun. 2011 can display identifiers respectively corresponding to a music play related setting item 91, a sound setting item 92, and a vibration setting item 93 in a thumbnail image. Accordingly, the user can easily recognize captured setting items by viewing the thumbnail image.

It can be seen from FIG. 31 that a Wi-Fi setting item 94 is captured on 30 Jul. 2011 and the Wi-Fi setting item 94 and a DLNA setting item 95 are captured and stored on 30 Aug. 2011.

Referring to FIG. 31, when the first thumbnail image Th1 is selected, the controller 180 can change setting values related to the sound, vibration and music play of the mobile terminal 100 to control setting values mapped to the first thumbnail image Th1.

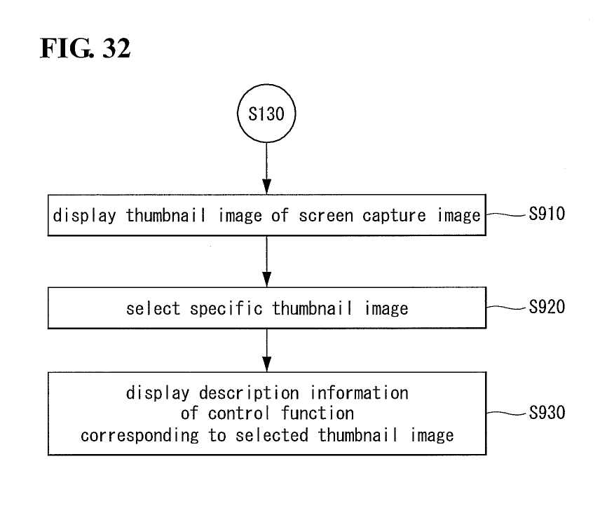

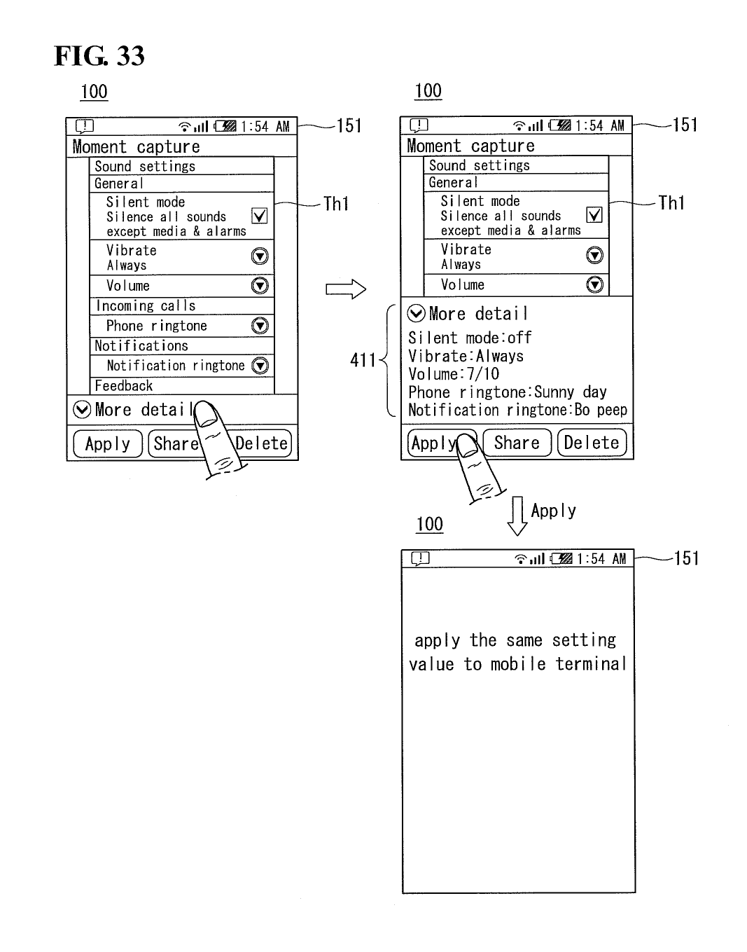

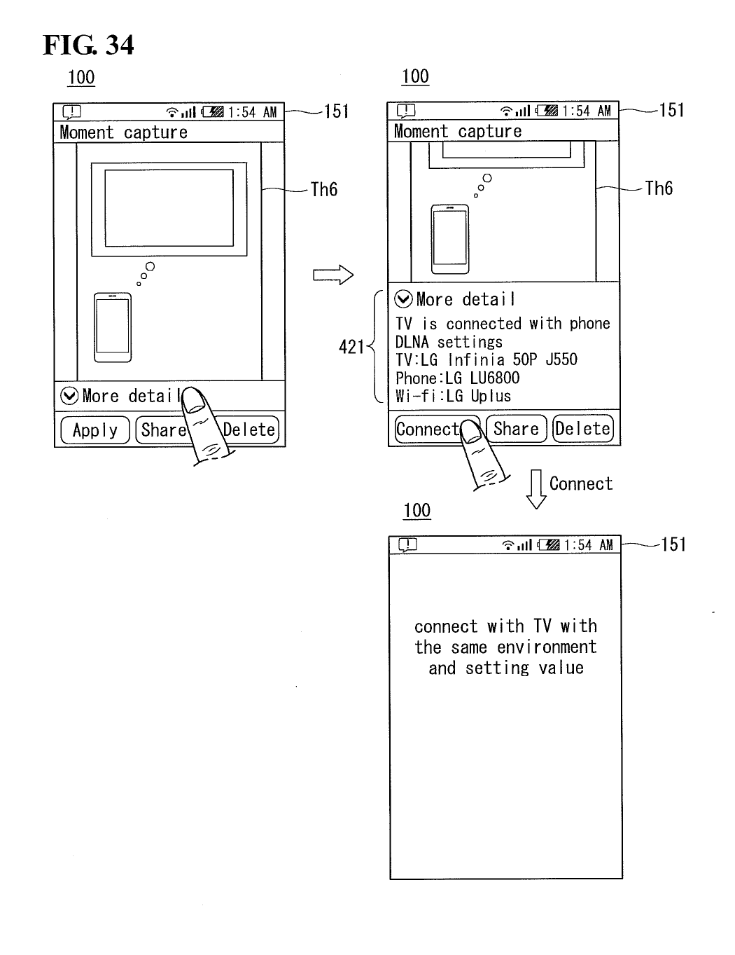

FIG. 32 is a flowchart illustrating a method of controlling the mobile terminal according to an embodiment of the present invention and FIGS. 33 and 34 illustrate the embodiment shown in FIG. 32.

Referring to FIG. 32, the controller 180 may map a screen capture image to one or more control functions corresponding to one or more items and store the screen capture image (S730 of FIG. 25).

Here, the controller 180 may store the screen capture image to which the control functions are mapped as a thumbnail image and display the thumbnail image on the touchscreen 151 (S910).

The controller 180 may receive an input for selecting a specific thumbnail image from one or more thumbnail images stored in the memory 160 (S920).

Then, the controller 180 may display description information about a control function corresponding to the selected thumbnail image on the touchscreen 151 (S930).

The description information may include a current setting value, details of setting, etc. with respect to the function of the screen-captured control item or the screen-captured control item.

Referring to FIG. 33, when the first thumbnail image Th1 is selected while a plurality of thumbnail images is displayed on the touchscreen 151, the controller 180 can provide detailed information 411 about a control function that can be set through the first thumbnail image Th1 on the touchscreen 151.

The detailed information 411 relates to the sound of the mobile terminal 100. The mobile terminal can be set to the silent mode and set to always vibration state, a volume can be set to 7, the phone ringtone can be set to “sunny day” and the notification ringtone can be set to “Bo peep” according to the detailed information 411.

FIG. 33 also shows that a user may select an “Apply” key. The controller 180 may then apply features (relating to the displayed detailed information 411) to the mobile terminal. In other words, setting values may be applied to the mobile terminal.

Referring to FIG. 34, detailed information 421 about a control function that can be set through the sixth thumbnail image Th6 may be displayed on the touch screen 151.

The detailed information 421 relates to connection between the mobile terminal 100 and an external device and may represent that the mobile terminal 100 (LGLU6800) can be connected with a TV receiver (LG Infinia 50pJ550) through DLNA and the mobile terminal 100 can set Wi-Fi (LG Uplus) and DLNA.

FIG. 34 also shows that a user may select a “connect” key. The controller 180 may then connect features (relating to the displayed detailed information 421) to the mobile terminal. In other words, the mobile terminal may connect with TV using same environment and setting value.

Embodiments of controlling the mobile terminal using a screen capture image have been described. The method of controlling the mobile terminal according to an embodiment of the present invention can be implemented through a predetermined application program by accessing the application program.

A description will be given of an example of accessing the application program for implementing a method of controlling the mobile terminal according to an embodiment of the present invention.

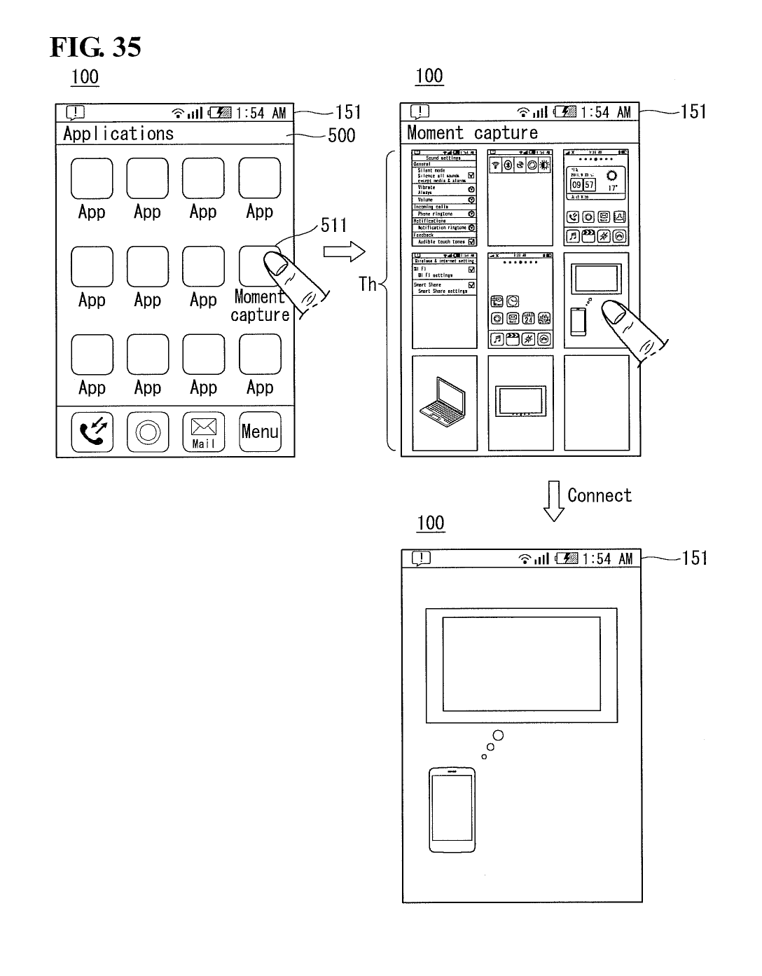

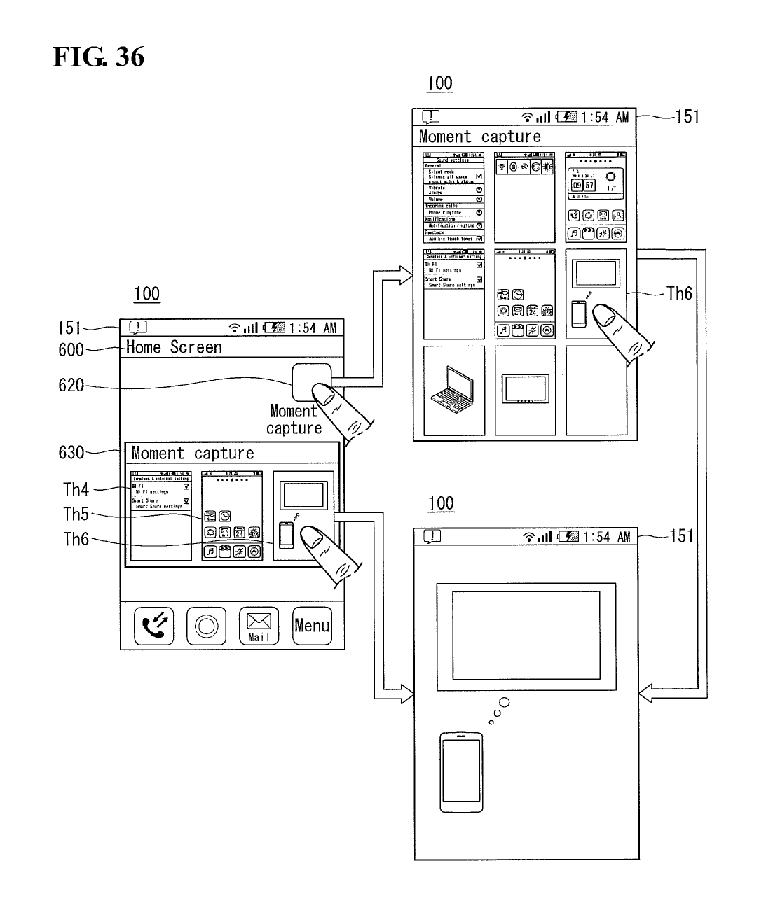

FIGS. 35 and 36 illustrate an example of accessing an application for executing a method of controlling the mobile terminal according to an embodiment of the present invention.

Referring to FIG. 35, a method of controlling the mobile terminal according to an embodiment of the present invention can be implemented through predetermined application programs 500 and 511 and the controller 180 may display the application programs 511 on the touchscreen 151.

The method of controlling the mobile terminal according to an embodiment of the present invention may be implemented by executing the application program 511.

Referring to FIG. 36, when an application program 620 is executed, one or more previously stored thumbnail images may be displayed on the touchscreen 151. Here, the one or more thumbnail images may be provided through a widget icon 630 and thus control functions corresponding to the thumbnail images can be directly executed.

One or more thumbnail images Th4, Th5 and Th6 which are generated by processing a screen capture image may be dynamically displayed through a widget icon 630. When a touch input (e.g. flicking input) for the widget icon 630 is applied, a control function mapped to a selected thumbnail image can be directly applied to the mobile terminal 100.

A screen captured according to a method of controlling the mobile terminal according to an embodiment of the present invention may correspond to the overall surface of the touchscreen 151 or part of the touchscreen 151.

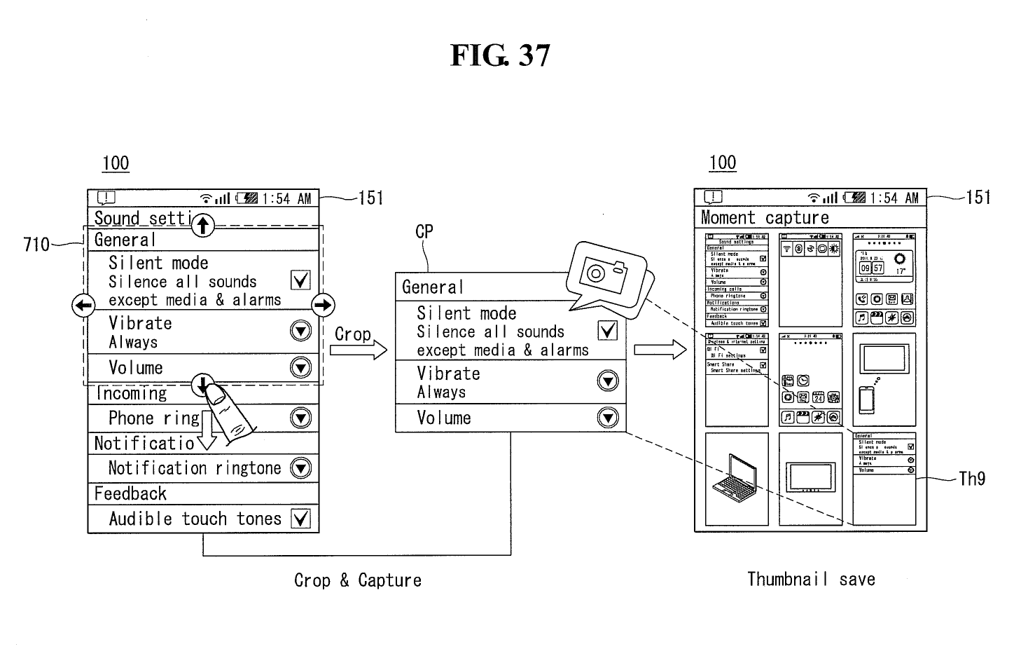

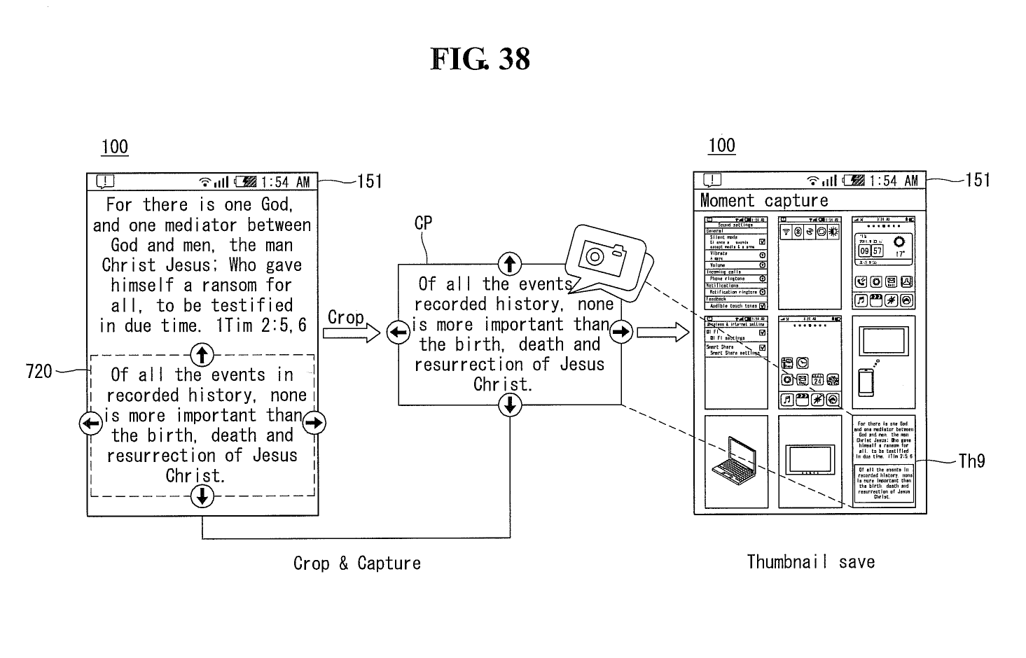

FIGS. 37 and 38 illustrate examples of setting a to-be-captured region according to the method of controlling the mobile terminal according to an embodiment of the present invention.

Referring to FIG. 37, the controller 180 may display a capture window 710 for controlling a capture range on the touchscreen 151. A screen capture range to which the embodiment of the present invention is applied can be controlled by adjusting the size of the capture window 710.

When screen capture is performed upon control of the capture range, the controller 180 can capture a screen included in the controlled capture range.

The controller 180 may map only a function corresponding to a control item included in the controlled capture range to the screen capture image.

A screen capture image Th9 whose capture range has been adjusted may be processed into a thumbnail image and stored.

In the above description, a target captured according to the method of controlling the mobile terminal according to an embodiment of the present invention is limited to items for controlling operations of the mobile terminal 100. However, the present invention is not limited thereto and the capture target can vary in various manners.

Referring to FIG. 38, the capture target displayed on the touchscreen 151 may be a text. A predetermined region 720 of the text may be captured. As described above, a capture range can be controlled by adjusting the size of the capture window 720.

The controller 180 may capture the text included in the capture window 720 and store the captured text as a thumbnail image Th9.

The stored thumbnail image Th9 may be used for text input. For example, the stored thumbnail image Th9 can be used when a message creation related application is executed.

Items for controlling the mobile terminal 100 may include a plurality of items that are composed of a plurality of stages and included in a lower category.

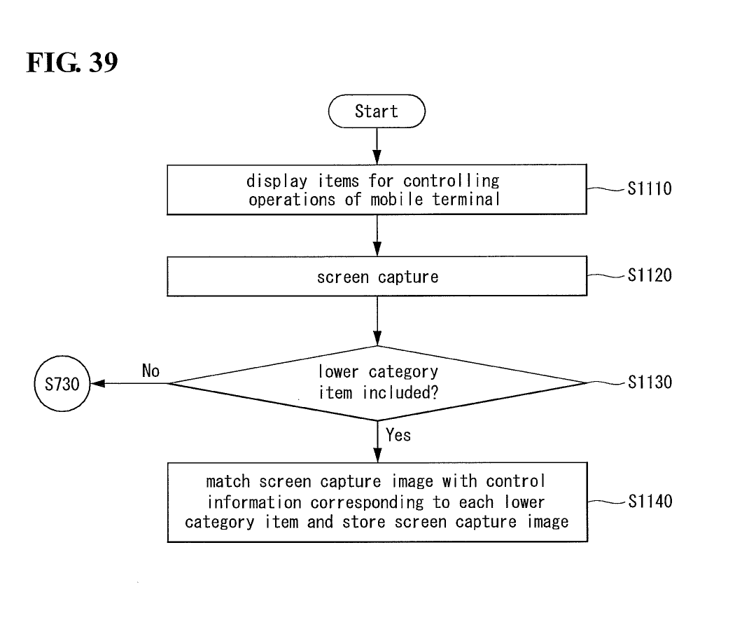

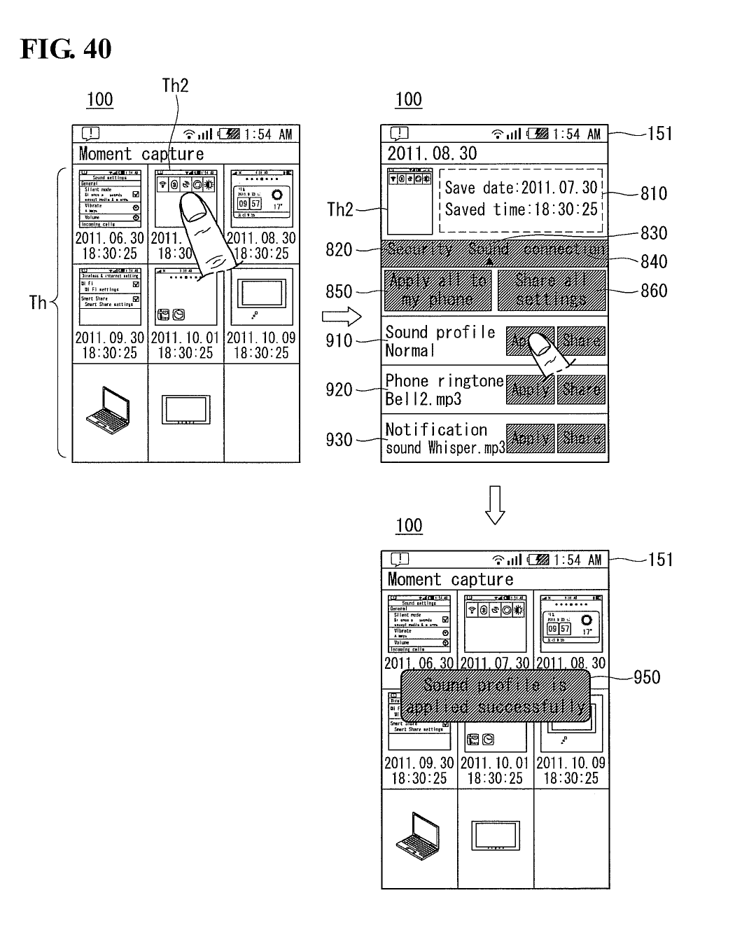

FIG. 39 is a flowchart illustrating a method of controlling the mobile terminal according to an embodiment of the present invention and FIG. 40 illustrates the embodiment shown in FIG. 39. The method of controlling the mobile terminal can be performed under the control of the controller 180.

Referring to FIG. 39, the controller 180 may display items for controlling operations of the mobile terminal on the touchscreen 151 (S1110).

When an image displayed on the touchscreen 151 is captured (S1120), the controller 180 determines whether items included in the capture image include a lower category item (S1130).

Here, a higher category can be a vibration setting item for the mobile terminal and a lower category can be a detailed vibration setting item, for example. The vibration setting item may include 1) always vibrate, 2) no vibrate, 3) vibrate only in silent mode, and 4) vibrate only in no silent mode as lower categories. It is assumed that the user selects item 3).

The controller 180 may map the screen capture image to control functions respectively corresponding to lower category items and store the screen capture image (S1140).

For example, while only the higher category “vibration setting item” is displayed on the screen capture image, the controller 180 can store setting values for lower categories which are not displayed on the touchscreen 151 along with the screen capture image.

An example of applying control functions corresponding to a plurality of lower category items to the mobile terminal 100 will now be described with reference to FIG. 40.

Referring to FIG. 40, when one Th2 of previously stored multiple thumbnail images Th is selected, the controller 180 may display description information 810 about the selected thumbnail image Th2.

The controller 180 may display a plurality of items 910, 920 and 930 belonging to a lower category of the selected thumbnail image Th2 on the touchscreen 151.

As shown in FIG. 40, control items 820, 830 and 840 of the higher category may be provided as a flicking tab. When a specific control item (e.g. sound 830) of the higher category is selected, lower category items of the selected item 830, 1) sound profile normal, 2) phone ringtone bell, and 3) notification sound whisper may be displayed.

The controller 180 can apply all the control functions related to the control items 910, 920 and 930 belonging to the lower category to the mobile terminal 100 or apply only an item selected by the user to the mobile terminal 100.

Reference numeral 850 denotes a button (apply all to may phone) for applying all the items 910, 920 and 930 belonging to the lower category to the mobile terminal 100 and reference numeral 860 denotes a button (share all settings) for sharing the items 910, 920 and 930 with an external device.

According to the method of controlling the mobile terminal according to an embodiment of the present invention, when a control item displayed on a screen capture image includes a plurality of lower category items, the lower category items may be displayed on the touchscreen 151 and at least one control function related to each lower category item may be applied to the mobile terminal 100.

The controller 180 may display a message 950 for signaling that at least one of the lower category items 910, 920 and 930 is successfully applied on the touchscreen 151.

According to an embodiment of the present invention, a screen capture image can be transmitted to an external device to easily set an operation state of the external device.

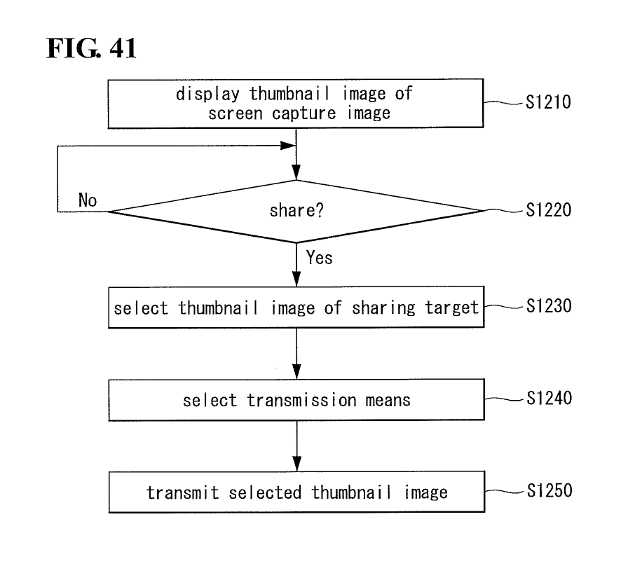

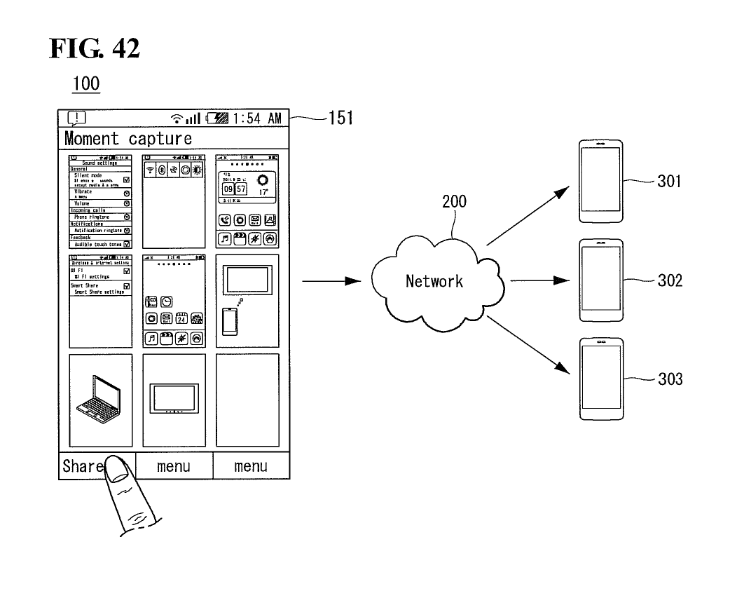

FIG. 41 is a flowchart illustrating a method of controlling the mobile terminal according to an embodiment of the present invention and FIG. 42 illustrates the embodiment shown in FIG. 41.

Referring to FIGS. 41 and 42, the controller 180 may display a thumbnail image of a screen capture image (S1210).

When a touch input for sharing at least one previously thumbnail image with an external device is selected (S1220) and a thumbnail image to be shared with the external device is selected (S1230), the controller 180 may transmit the selected thumbnail image to the external device.

The controller 180 may select a predetermined network for transmitting the selected thumbnail image (S1230).

The controller 180 may transmit the selected thumbnail image to one or more external devices 301, 302 and 303 through the predetermined network 200, for example, DLNA, Wi-Fi direct, Bluetooth, mobile network, etc. (S1240).

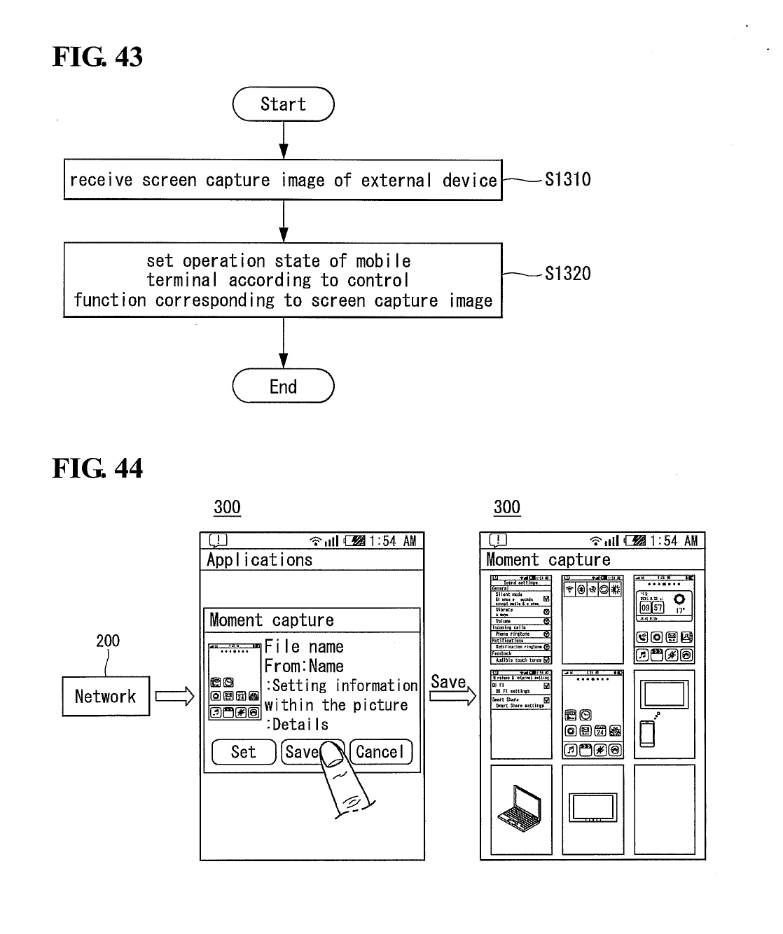

Operations of the external devices 301, 302 and 303 receiving the thumbnail image will now be described with reference to FIGS. 43 to 45.

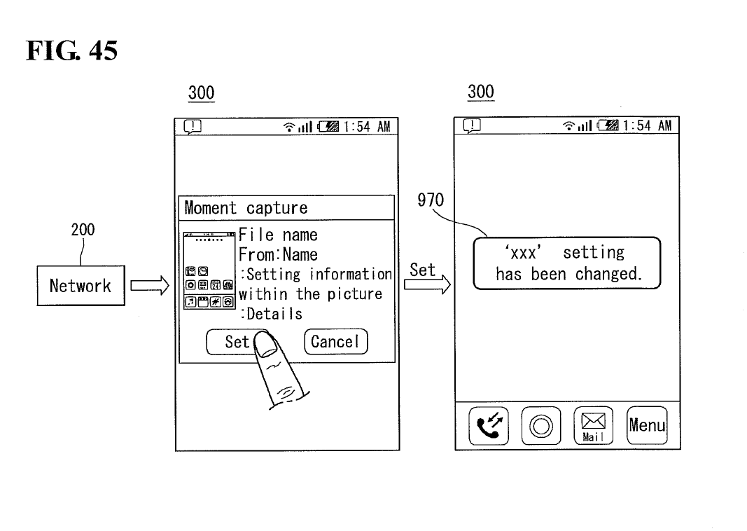

FIG. 43 is a flowchart illustrating a method of controlling a mobile terminal according to an embodiment of the present invention and FIGS. 44 and 45 illustrate the embodiment shown in FIG. 43. The method of controlling a mobile terminal can be performed under the control of the controller 180.

Referring to FIG. 43, a mobile terminal 300 may receive a screen capture image of an external device through a wireless communication unit thereof (S1310).

The mobile terminal 300 may receive the screen capture image from a server of a mobile carrier or a server provided through a cloud computer service.

The mobile terminal 300 may set an operation state thereof according to a control function corresponding to the received screen capture image (S1320).

The mobile terminal 300 may extract a control function mapped to the received screen capture image by parsing the screen capture image. The extraction result may be applied to the mobile terminal 300 and may include a setting value related to the operation state of the mobile terminal 300.

An application for implementing the method of controlling a mobile terminal according to an embodiment of the present invention may be provided, and a procedure for processing the screen capture image received from an external device may depend on presence or absence of the application.

Referring to FIG. 44, upon reception of a screen capture image from an external device through a network 200, the mobile terminal 300 may automatically execute the application and store the received screen capture image in the memory.

Referring to FIG. 45, when the screen capture image is received from the external device through the network 200 while the application is not installed in the mobile terminal 300, the mobile terminal 300 may set the operation state thereof to a control function corresponding to the received screen capture image.

Furthermore, the mobile terminal 300 may display a message 970 signaling that the operation state of the mobile terminal 300 is set on the touchscreen 151 through the screen capture image received from the external device.

The method for controlling of the mobile terminal according to embodiments of the present invention may be recorded in a computer-readable recording medium as a program to be executed in the computer and provided. Further, the method for controlling a mobile terminal according to embodiments of the present invention may be executed by software. When executed by software, the elements of the embodiments of the present invention are code segments executing a required operation. The program or the code segments may be stored in a processor-readable medium or may be transmitted by a data signal coupled with a carrier in a transmission medium or a communication network.

The computer-readable recording medium includes any kind of recording device storing data that can be read by a computer system. The computer-readable recording device includes a ROM, a RAM, a CD-ROM, a DVD-ROM, a DVD-RAM, a magnetic tape, a floppy disk, a hard disk, an optical data storage device, and the like. Also, codes which are distributed in computer devices connected by a network and can be read by a computer in a distributed manner are stored and executed in the computer-readable recording medium.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a touchscreen to display an image relating to a specific webpage; and
a controller configured to capture the image relating to the webpage, the controller to map universal resource locator (URL) information of the webpage to the captured image and to store the captured image having the mapped URL information, and in response to receiving a touch input, the controller to execute the webpage corresponding to the captured image based at least in part on the mapped URL information.

2. The mobile terminal of claim 1, wherein the controller captures the image relating to the webpage in response to receiving a screen capture input for the image relating to the webpage.

3. The mobile terminal of claim 2, wherein the screen capture input is a long touch input according to a first touch and a second touch on the touchscreen.

4. The mobile terminal of claim 2, wherein the touchscreen to display an image capture icon, and the screen capture input is a selection of the image capture icon.

5. The mobile terminal of claim 4, wherein the controller to change a visual appearance of the image capture icon in response to the image of the webpage being captured.

6. The mobile terminal of claim 1, wherein the controller to display, on the touchscreen, an identifier to indicate that the URL information is mapped to the captured image relating to the specific webpage.

7. The mobile terminal of claim 6, wherein the touch input is a touch input to the identifier.

8. The mobile terminal of claim 1, wherein the touch input is a double tap input to the captured image related to the webpage.

9. The mobile terminal of claim 1, wherein the touch input is a scroll motion over the captured image, and the controller provides the webpage based on the scroll motion over the captured image.

10. The mobile terminal of claim 1, wherein the controller to execute the webpage includes the controller accessing the webpage using the URL of the captured image without executing a specific web browser.

11. The mobile terminal of claim 1, further comprising:
a wireless communication unit, wherein the controller to transmit the captured image to at least one external device through the wireless communication unit.

12. The mobile terminal of claim 11, wherein the controller to include at least one link information for executing the webpage corresponding to the captured image and to transmit the captured image including the link information.

13. A method of controlling a mobile terminal, the method comprising:
displaying a specific webpage on a touchscreen;
generated a captured image of the webpage by capturing a screen on which the webpage is displayed;
mapping universal resource locator (URL) information of the webpage to the captured image and storing, in a memory, the captured image that includes the mapped URL information;
receiving a touch input to select the captured image corresponding to the specific webpage; and
applying the URL corresponding to the selected captured image to access the specific webpage corresponding to the URL.

14. The method of claim 13, wherein generating the captured image occurs in response to receiving a screen capture input relating to the webpage.

15. The method of claim 14, further comprising displaying an image capture icon on the touchscreen, and receiving the screen capture input includes receiving a selection of the image capture icon.

16. The method of claim 13, wherein the touch input is a touch input related to an identifier that indicates that the URL information is mapped to the captured image of the webpage.

17. The method of claim 13, wherein the touch input is a double tap input to the captured image of the specific webpage.

18. The method of claim 13, wherein the touch input is a scroll motion over the captured image, and the webpage is provided on the touchscreen based on the scroll motion over the captured image of the specific webpage.

19. The method of claim 13, wherein applying the URL includes accessing the webpage using the URL of the captured image without executing a specific web browser.

20. The method of claim 13, further comprising transmitting the captured image to at least one external device through a wireless communication unit of the mobile terminal.

21. A mobile terminal comprising:
a touchscreen; and
a controller to display, on the touchscreen, a plurality of settings for controlling operations of the mobile terminal, the controller to obtain a captured image of the plurality of settings displayed on the touchscreen, the controller to map control functions corresponding to the plurality of settings of the captured image and to store the captured image, and in response to selection of one of a plurality of captured images, the controller to set an operation state of the mobile terminal based on a control function corresponding to the selected captured image.

22. The mobile terminal of claim 21, wherein at least one of the plurality of settings corresponds to sound.

23. The mobile terminal of claim 21, further comprising a wireless communication unit to communicate with an external device, and the controller to send information of the selected captured image to the external device.

24. The mobile terminal of claim 21, wherein the touchscreen to display a plurality of captured images.

25. The mobile terminal of claim 24, wherein one of the displayed captured images relating to settings of another terminal.

26. The mobile terminal of claim 25, wherein in response to selection of the one of the displayed captured images, displaying a message, on the touchscreen, indicating that a control function of the selected captured image can not be performed on the mobile terminal.

27. The mobile terminal of claim 21, wherein the plurality of settings correspond to a data list that includes one or more data items, the one or more data items corresponding to at least one of a text and setting information for controlling operation of the mobile terminal.

28. The mobile terminal of claim 21, wherein the controller to display a message, on the touchscreen, identifying that the operation state of the mobile terminal is set based on the control function corresponding to the selected screen captured image.
